(19) United States
(12) Patent Application Publication
(10) Pub. No.: US 2025/0371905 A1
(43) Pub. Date: Dec. 4, 2025

(54) PALM FEATURE PROCESSING METHOD AND APPARATUS FOR IDENTITY AUTHENTICATION, DEVICE, AND MEDIUM

(71) Applicant: Tencent Technology (Shenzhen) Company Limited, Shenzhen (CN)

(72) Inventor: Zhenhong ZHANG, Shenzhen (CN)

(21) Appl. No.: 19/305,647

(22) Filed: Aug. 20, 2025

Related U.S. Application Data
(63) Continuation of application No. PCT/CN2024/097685, filed on Jun. 6, 2024.

(30) Foreign Application Priority Data
Aug. 17, 2023 (CN) 202311035766.9

(51) Int. Cl. G06V 40/12; G06V 10/40; G06V 10/764; G06V 10/774

(52) U.S. Cl. CPC G06V 40/1347; G06V 10/40; G06V 10/764; G06V 10/774; G06V 40/1335; G06V 40/1365

(57) ABSTRACT

A method for palm feature-based identity authentication is performed by a computer device and the method includes: acquiring a plurality of palm images of a palm at different acquisition angles; for each palm image, positioning a palm key region in the palm image according to an acquisition angle of the palm image and determining an auxiliary region in the palm image except the palm key region; performing feature extraction on the palm image to obtain a single-angle palm feature of the palm image, a contribution weight assigned to the palm key region in the palm image being higher than a contribution weight assigned to the auxiliary region in the palm image; fusing single-angle palm features of the plurality of palm images to obtain a multi-angle palm feature of the palm; and performing identity authentication using the multi-angle palm feature.

### CROSS-REFERENCE TO RELATED APPLICATIONS

This application is a continuation application of PCT Patent Application No. PCT/CN2024/097685, entitled “PALM FEATURE PROCESSING METHOD AND APPARATUS FOR IDENTITY AUTHENTICATION, DEVICE, AND MEDIUM” filed on Jun. 6, 2024, which claims priority to Chinese Patent Application No. 2023110357669, entitled “PALM FEATURE PROCESSING METHOD AND APPARATUS FOR IDENTITY AUTHENTICATION, DEVICE, AND MEDIUM” filed on Aug. 17, 2023, both of which are incorporated herein by reference in their entirety.

### FIELD OF THE TECHNOLOGY

This application relates to artificial intelligence technologies, and in particular, to a palm feature processing method and apparatus for identity authentication, a device, and a medium.

### BACKGROUND OF THE DISCLOSURE

Palm recognition is a biological feature recognition technology based on palm texture and has the following characteristics and benefits: uniqueness: makes palm recognition a highly reliable personal identity authentication manner; difficulty in forgery: compared with other biological feature recognition technologies, palm texture is not easy to be forged; high efficiency: the palm recognition technology has relatively low requirements on acquisition and recognition speeds and can implement fast identity authentication; non-contact: palm recognition does not need to contact a special device and only needs to acquire the palm through a camera or sensor, which makes palm recognition more hygienic, convenient, and comfortable; and diversity: the palm recognition technology is applicable to people of all ages and genders. The palm recognition technology may be widely applied to various fields related to identity authentication, such as Internet security, payment systems, access control systems, and self-service devices. With its uniqueness, difficulty in forgery, and high efficiency, the palm recognition technology has become a convenient, secure, and reliable personal identity authentication manner and has a wide application prospect in many application fields.

In a traditional manner of implementing identity authentication based on a palm, identity authentication is usually performed based on a single-angle palm image, and feature information of the palm image involved in the identity authentication process is limited, which affects the effect of identity authentication. In addition, the accuracy of identity authentication is relatively low, resulting in the waste of hardware resources for supporting an identity authentication function.

### SUMMARY

Provided are a palm feature processing method and apparatus for identity authentication, a device, and a medium.

According to an aspect, this application provides a method for palm feature-based identity authentication, which is performed by a computer device and the method includes the following operations:
acquiring a plurality of palm images of a palm at different acquisition angles;
for each palm image, positioning a palm key region in the palm image according to an acquisition angle of the palm image and determining an auxiliary region in the palm image except the palm key region;
performing feature extraction on the palm image to obtain a single-angle palm feature of the palm image, a contribution weight assigned to the palm key region in the palm image being higher than a contribution weight assigned to the auxiliary region in the palm image;
fusing single-angle palm features of the plurality of palm images to obtain a multi-angle palm feature of the palm; and
performing identity authentication using the multi-angle palm feature.

According to a second aspect, this application provides a computer device, including a memory and a processor, the memory having a computer program stored therein, and the computer program, when executed by the processor, causing the computer device to implement operations in the method embodiments of this application.

According to a third aspect, this application provides a non-transitory computer-readable storage medium, having a computer program stored therein, the computer program, when executed by a processor of a computer device, causing the computer device to implement operations in the method embodiments of this application.

The details of one or more embodiments of this application are set forth in the accompanying drawings and the descriptions below. Other features, objectives, and advantages of this application become apparent from the specification, the drawings, and the claims.

### BRIEF DESCRIPTION OF THE DRAWINGS

To more clearly illustrate the technical solutions in the embodiments of this application or in the related art, the drawings required in the descriptions of the embodiments or the related art will be briefly introduced below. Obviously, the drawings described below are only embodiments of this application, and a person skilled in the art may obtain other drawings according to the disclosed drawings without involving any inventive effort.

FIG. 1 is a diagram of an application environment of a palm feature processing method for identity authentication according to an embodiment.

FIG. 2 is a schematic flowchart of a palm feature processing method for identity authentication according to an embodiment.

FIG. 3 is a schematic diagram of acquiring a plurality of acquired images of the same palm at different acquisition angles according to an embodiment.

FIG. 4 is a schematic diagram of a position of a palm key region included in a palm region according to an embodiment.

FIG. 5 is a flowchart of super-resolution reconstruction according to an embodiment.

FIG. 6 is a flowchart of super-resolution reconstruction implemented based on a super-resolution model according to an embodiment.

FIG. 7 is a model structure diagram of a super-resolution model according to an embodiment.

FIG. 8 is a schematic diagram of a training principle of a feature extraction model according to an embodiment.

FIG. 9 is an overall framework diagram of identity authentication implemented based on a palm authentication manner according to an embodiment.

FIG. 10 is a schematic flowchart of a palm feature processing method for identity authentication according to another embodiment.

FIG. 11 is a schematic diagram of a palm feature processing method for identity authentication being applied to a scene in which identity authentication is performed using a palm to log in to an instant messaging application according to an embodiment.

FIG. 12 is a schematic diagram of a palm feature processing method for identity authentication being applied to a scene in which identity authentication is performed using a palm to realize resource transfer according to an embodiment.

FIG. 13 is a structural block diagram of a palm feature processing apparatus for identity authentication according to an embodiment.

FIG. 14 is a structural block diagram of a palm feature processing apparatus for identity authentication according to another embodiment.

FIG. 15 is a diagram of an internal structure of a computer device according to an embodiment.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person skilled in the art based on the embodiments of this application without inventive efforts fall within the scope of this application.

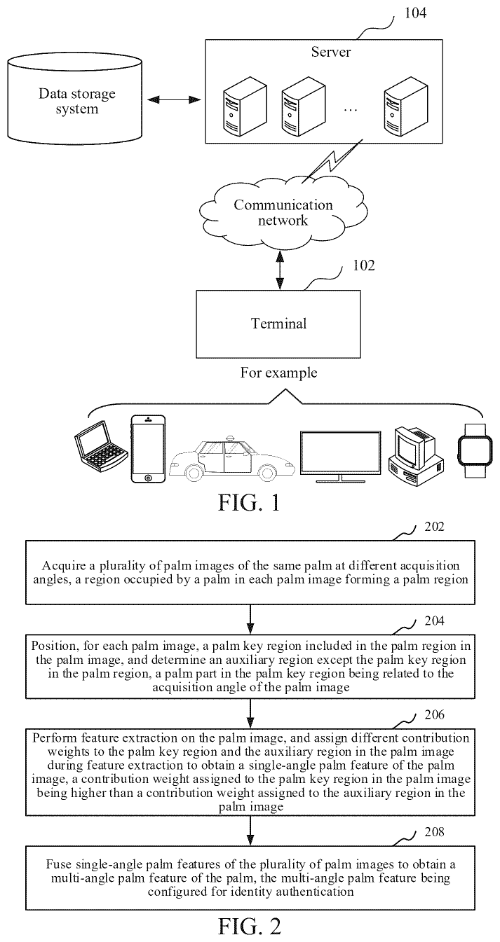

A palm feature processing method for identity authentication provided in this application may be applied to an application environment shown in FIG. 1. A terminal 102 communicates with a server 104 through a network. A data storage system may be provided separately and may store data that needs to be processed by the server 104. The data storage system may be integrated on the server 104, or may be placed on the cloud or another server. The terminal 102 may be, but not limited to, various desktop computers, a notebook computer, a smartphone, a tablet computer, an Internet of Things device, and a portable wearable device. The Internet of Things device may be a smart speaker, a smart television, a smart air conditioner, a smart in-vehicle device, or the like. The portable wearable device may be a smart watch, a smart band, a head-mounted device, or the like. A camera configured to acquire palm images is deployed in the terminal 102. The server 104 may be an independent physical server, may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, network security services such as cloud security and host security, a content delivery network (CDN), and a big data and artificial intelligence platform. The terminal 102 and the server 104 may be directly or indirectly connected in a wired or wireless communication manner. This is not limited in this application.

The server 104 may acquire a plurality of palm images of the same palm at different acquisition angles, a region occupied by a palm in each palm image forming a palm region; and position, for each palm image, a palm key region included in the palm region in the palm image, and determine an auxiliary region except the palm key region in the palm region. A palm part in the palm key region is related to the acquisition angle of the palm image. The server 104 may perform feature extraction on the palm image, and assign different contribution weights to the palm key region and the auxiliary region in the palm image during feature extraction to obtain a single-angle palm feature of the palm image. A contribution weight assigned to the palm key region in the palm image is higher than a contribution weight assigned to the auxiliary region in the palm image. The server 104 may fuse single-angle palm features of the plurality of palm images to obtain a multi-angle palm feature of the palm. The multi-angle palm feature is configured for identity authentication.

The terminal 102 may acquire a plurality of palm images of the same palm at different acquisition angles and transmit the plurality of palm images to the server 104, and the server 104 may receive the plurality of palm images transmitted by the terminal 102. The server 104 may further acquire a plurality of palm images of the same palm at different acquisition angles from a third-party storage device. This is not limited in this embodiment. The application scene in FIG. 1 is merely illustrative and is not limited thereto.

The palm feature processing method for identity authentication in some embodiments of this application uses the artificial intelligence technology. For example, the palm key region is positioned using the artificial intelligence technology, and the single-angle palm feature of the palm image is also encoded using the artificial intelligence technology. To facilitate understanding of artificial intelligence, the concept of artificial intelligence is now explained. Specifically, artificial intelligence involves a theory, a method, a technology, and an application system that use a digital computer or a machine controlled by the digital computer to simulate, extend, and expand human intelligence, perceive an environment, acquire knowledge, and use knowledge to obtain an optimal result. In other words, artificial intelligence is a comprehensive technology in computer science, attempts to understand the essence of intelligence, and produce a new intelligent machine that can react in a manner similar to human intelligence. Artificial intelligence is to study the design principles and implementation methods of various intelligent machines to enable the machines to have the functions of perception, reasoning, and decision-making. In this application, positioning of the palm key region and extraction of the single-angle palm feature of the palm image are implemented based on the artificial intelligence technology so that the accuracy of identity authentication may be further improved, thereby further avoiding the waste of hardware resources configured for supporting an identity authentication function.

In an embodiment, as shown in FIG. 2, a palm feature processing method for identity authentication is provided. In this embodiment, an example in which the method is applied to the server 104 in FIG. 1 is used for description. The method includes the following operations.

Operation 202: Acquire a plurality of palm images of the same palm at different acquisition angles, a region occupied by a palm in each palm image forming a palm region.

The acquisition angle is an angle formed between an orientation of the palm in an imaging plane and a calibration direction of an image acquisition device when the image acquisition device performs image acquisition on the palm. The orientation of the palm may be a direction indicated by two key points on the palm that are fixed relative to the palm, or may be a direction from a palm center of the palm to a middle finger of the palm. The key point may be a connection of two adjacent fingers. The calibration direction is a preset direction of the image acquisition device in the imaging plane. For example, an upward direction (or any other specified direction) in the imaging plane is used as the calibration direction.

The palm image is an image obtained by performing image acquisition on the palm. The acquisition angle may specifically include a frontal angle, an inclined angle, a side angle, or the like. The palm region may be a region surrounding the palm in the palm image. Compared with the palm image, the palm region has less redundancy except the palm.

In an embodiment, the image acquisition device may be deployed on the terminal, and a user to which the palm belongs may place the same palm within a field of view range of the image acquisition device at different angles. The terminal may perform, through the image acquisition device, image acquisition on the same palm placed at different angles above the image acquisition device to obtain a plurality of acquired images of the same palm at different acquisition angles. Further, the terminal may transmit the plurality of acquired images to the server, and the server may receive the plurality of acquired images transmitted by the terminal and directly use the plurality of acquired images as the plurality of palm images.

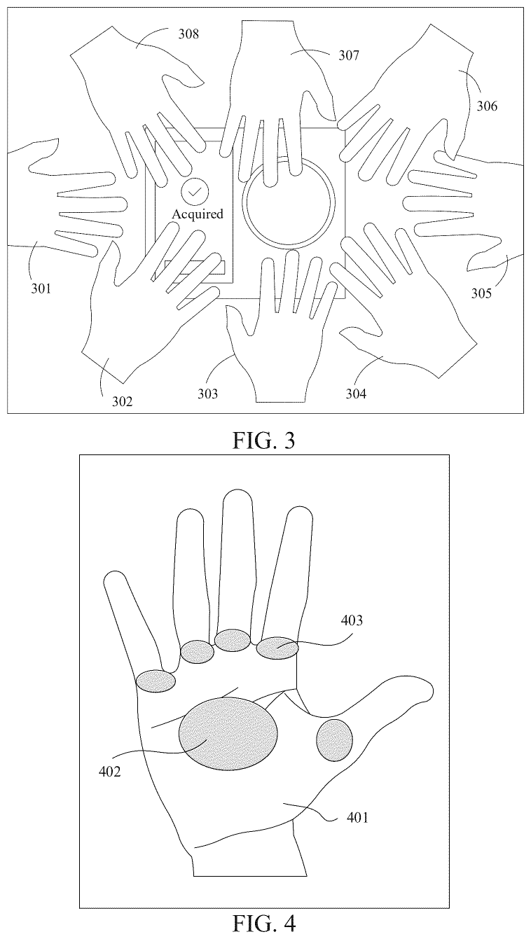

In an embodiment, as shown in FIG. 3, a terminal may perform, through the image acquisition device, image acquisition on the same palm placed at different angles above the image acquisition device to obtain a plurality of acquired images of the same palm at different acquisition angles. The same palm may be placed at eight different positions 301 to 308 to acquire eight acquired images of the same palm at different acquisition angles.

In an embodiment, a third-party storage device may store a plurality of acquired images of the same palm at different acquisition angles, and a server may directly acquire the plurality of acquired images of the same palm at different acquisition angles from the third-party storage device and directly use the plurality of acquired images as the palm images.

In an embodiment, the server may acquire the plurality of acquired images of the same palm at different acquisition angles and perform image resolution improvement on the plurality of acquired images to obtain a plurality of palm images. A resolution of the palm image is higher than a resolution of the acquired image corresponding to the palm image.

In an embodiment, the server may acquire the plurality of acquired images of the same palm at different acquisition angles and perform pixel interpolation on the plurality of acquired images to correspondingly obtain a plurality of palm images. The resolution of the palm image is higher than the resolution of the acquired image corresponding to the palm image. The interpolation may use bilinear interpolation, bicubic interpolation, or the like. In this embodiment, interpolation calculation is performed between known pixel values of the acquired image to generate a new pixel value, thereby improving the resolution of the image.

Operation 204: Position, for each palm image, a palm key region included in the palm region in the palm image, and determine an auxiliary region except the palm key region in the palm region, a palm part in the palm key region being related to the acquisition angle of the palm image.

The palm key region is a region having a unique biological feature in the palm image. The auxiliary region is a region except the palm key region in the palm region of the palm image. Compared with the auxiliary region, the palm key region in the palm image has a more unique biological feature, is more forging-resistant, and has higher recognition accuracy and security in the field of identity authentication.

Specifically, for each of the plurality of acquired palm images, the server may perform key region recognition on the palm image to position the palm key region included in the palm region in the palm image. After the palm key region included in the palm region in the palm image is positioned, a region except the palm key region in the palm image is the auxiliary region included in the palm image.

In an embodiment, for each of the plurality of acquired palm images, the server may extract an image feature of the palm image and position the palm key region included in the palm region in the palm image according to the extracted image feature.

In an embodiment, for each of the plurality of acquired palm images, the server may input the palm image to a pre-trained key region recognition model to extract the image feature of the palm image through the pre-trained key region recognition model, and position and output the palm key region included in the palm region in the palm image according to the extracted image feature. The key region recognition model belongs to a target detection model and has a capability of recognizing the palm key region from the palm image.

In an embodiment, as shown in FIG. 4, the palm key region of the palm image may specifically include at least one of a palm center region 402 in a palm region 401, regions 403 between fingers and the palm center, or the like. The palm center region 402 is a region that is in the palm region 401 and contains the palm center in the palm image. The palm center is a central region of the palm and has many unique texture and skin characteristics on the skin, and the texture characteristics of the palm center are relatively stable. In addition, the palm center has many sweat glands and sebaceous glands, whose secretions may provide additional biological feature information during palm-based identity authentication. The regions between the fingers and the palm center include root connection regions of the thumb and the other four fingers and are transition regions of the biological features of the palm. On these regions, the skin on the dorsal and palmar sides of the fingers has unique texture and features.

For ease of further understanding that the palm part in the palm key region is related to the acquisition angle of the palm image, description is made using an example. When the acquisition angle is a frontal angle, the palm key region included in the palm region in the palm image is the palm center region. When the acquisition angle is an inclined angle, the palm key region included in the palm region in the palm image may be the region between the finger and the palm center.

Operation 206: Perform feature extraction on the palm image, and assign different contribution weights to the palm key region and the auxiliary region in the palm image during feature extraction to obtain a single-angle palm feature of the palm image, a contribution weight assigned to the palm key region in the palm image being higher than a contribution weight assigned to the auxiliary region in the palm image.

The single-angle palm feature is a feature extracted from a single palm image. The single palm image is any one of the plurality of palm images of the same palm at different acquisition angles.

Specifically, when feature extraction is performed on a palm image in the plurality of palm images, the server may assign a higher contribution weight to the palm key region in the palm image compared to the auxiliary region to obtain the single-angle palm feature of the palm image. When feature extraction is performed on a palm image in the plurality of palm images, the server may pay more attention to the palm key region in the palm image than to the auxiliary region in the palm image. The single-angle palm feature may characterize shallow features of the palm and may specifically characterize a basic structure of the palm in the palm image and a local feature of the palm at the acquisition angle of the palm image.

In an embodiment, the server may input the palm image to a pre-trained feature extraction model to perform feature extraction on the palm image through the feature extraction model, and assign different contribution weights to the palm key region and the auxiliary region in the palm image during feature extraction to obtain the single-angle palm feature of the palm image. The contribution weight assigned to the palm key region in the palm image is higher than the contribution weight assigned to the auxiliary region in the palm image. The feature extraction model is a neural network model configured to extract features from an image and has a capability of extracting the single-angle palm feature from the palm image.

Operation 208: Fuse single-angle palm features of the plurality of palm images to obtain a multi-angle palm feature of the palm, the multi-angle palm feature being configured for identity authentication.

The multi-angle palm feature is a feature obtained by fusing the single-angle palm features of the plurality of palm images of the same palm at different acquisition angles. The multi-angle palm feature characterizes deep features of the palm and may specifically characterize a palm structure and local features of the palm at multiple acquisition angles, thereby more comprehensively reflecting detailed features of the palm. The multi-angle palm feature is a comprehensive feature representation of the single-angle palm features of the plurality of palm images and has richer feature information than a single-angle palm feature of any palm image.

In an embodiment, the server may perform weighted summation on the single-angle palm features of the plurality of palm images to obtain the multi-angle palm feature of the palm. The server may assign corresponding weights to the single-angle palm features of the plurality of palm images and weight the single-angle palm features of the plurality of palm images based on the assigned weights to obtain the multi-angle palm feature of the palm.

In an embodiment, the server may perform feature cascading on the single-angle palm features of the plurality of palm images to obtain the multi-angle palm feature of the palm. The server may concatenate the single-angle palm features of the plurality of palm images to obtain the multi-angle palm feature of the palm.

In an embodiment, the server may perform feature selection on the single-angle palm features of the plurality of palm images to obtain the multi-angle palm feature of the palm. The server may select, from the single-angle palm features of the plurality of palm images, a single-angle palm feature with the richest feature information as the multi-angle palm feature of the palm.

In the foregoing palm feature processing method for identity authentication, the plurality of palm images of the same palm at different acquisition angles are acquired. For each palm image, the palm key region included in the palm region in the palm image is positioned, and the auxiliary region except the palm key region in the palm region is determined. The palm part in the palm key region is related to the acquisition angle of the palm image. Feature extraction is performed on the palm image, and different contribution weights are assigned to the palm key region and the auxiliary region in the palm image during feature extraction to obtain the single-angle palm feature of the palm image. The contribution weight assigned to the palm key region in the palm image is higher than the contribution weight assigned to the auxiliary region in the palm image. The single-angle palm features of the plurality of palm images are fused to obtain the multi-angle palm feature of the palm, and the multi-angle palm feature may be configured for identity authentication. Compared with a traditional manner of performing identity authentication based on a single-angle palm image, in this application, the plurality of palm images of the same palm at different acquisition angles are acquired, and the palm key region of the palm image is positioned so that more attention is paid to the palm key region during feature extraction to extract a single-angle palm feature of the palm image that is more accurately positioned. Further, the single-angle palm features of the palm images are fused into a richer and more accurate multi-angle palm feature, and identity authentication is performed based on the richer and more accurate multi-angle palm feature so that the accuracy of identity authentication may be improved, thereby avoiding the waste of hardware resources configured for supporting the identity authentication function.

In an embodiment, the acquiring a plurality of palm images of the same palm at different acquisition angles includes: acquiring a plurality of acquired images of the same palm at different acquisition angles; and performing super-resolution reconstruction on the plurality of acquired images to correspondingly obtain the plurality of palm images, a resolution of the palm image being higher than a resolution of the acquired image corresponding to the palm image.

The acquired image is an image obtained by performing image acquisition on the palm and on which super-resolution reconstruction is not performed.

Specifically, the server may acquire the plurality of acquired images of the same palm at different acquisition angles and perform super-resolution reconstruction on the plurality of acquired images to obtain the plurality of palm images corresponding to the plurality of acquired images. The palm image obtained after super-resolution reconstruction has a higher resolution than a corresponding acquired image before super-resolution reconstruction.

In an embodiment, for each acquired image, when performing super-resolution reconstruction on the acquired image, the server may assign the same contribution weight to pixel regions in the acquired image to obtain the palm image corresponding to the acquired image through reconstruction.

In the foregoing embodiment, super-resolution reconstruction is performed on the plurality of acquired images to correspondingly obtain the plurality of palm images, thereby improving the resolution of the image and obtaining an image with better quality. In particular, more precise and accurate image reconstruction may be performed on complex texture and details in the image, thereby effectively improving the resolution of the image, further improving the accuracy of identity authentication, and avoiding the waste of hardware resources configured for supporting the identity authentication function.

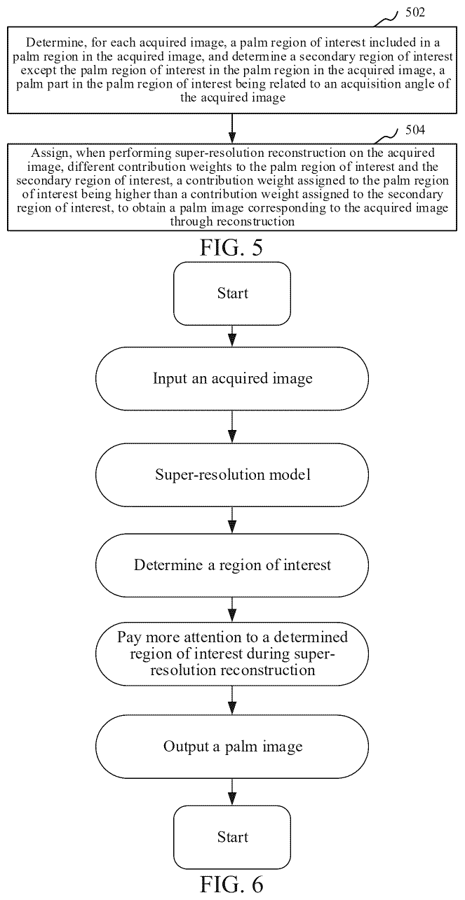

In an embodiment, as shown in FIG. 5, the performing super-resolution reconstruction on the plurality of acquired images to correspondingly obtain the plurality of palm images includes the following operations.

Operation 502: Determine, for each acquired image, a palm region of interest included in a palm region in the acquired image, and determine a secondary region of interest except the palm region of interest in the palm region in the acquired image, a palm part in the palm region of interest being related to the acquisition angle of the acquired image.

The palm region of interest is a region having a unique biological feature in the acquired image acquired for the palm. The secondary region of interest is a region except the palm region of interest in the acquired image acquired for the palm. Compared with the secondary region of interest, the palm region of interest in the acquired image has a more unique biological feature, is more forging-resistant, and has higher recognition accuracy and security in the field of identity authentication.

Specifically, for each of the plurality of acquired images, the server may perform region of interest recognition on the acquired image to position the palm region of interest included in the palm region in the acquired image. After the palm region of interest included in the palm region in the acquired image is positioned, a region except the palm region of interest in the acquired image is the secondary region of interest included in the acquired image.

In an embodiment, for each of the plurality of acquired images, the server may extract an image feature of the acquired image and position the palm region of interest included in the palm region in the acquired image according to the extracted image feature.

In an embodiment, for each of the plurality of acquired images, the server may input the acquired image to a pre-trained region of interest recognition model to extract the image feature of the acquired image through the pre-trained region of interest recognition model, and position and output the palm region of interest included in the palm region in the acquired image according to the extracted image feature. The region of interest recognition model belongs to a target detection model and has a capability of recognizing the palm region of interest from the acquired image.

In an embodiment, the palm region of interest may specifically include at least one of a palm center region, regions between fingers and the palm center, or the like.

Operation 504: Assign, when performing super-resolution reconstruction on the acquired image, different contribution weights to the palm region of interest and the secondary region of interest, a contribution weight assigned to the palm region of interest being higher than a contribution weight assigned to the secondary region of interest, to obtain the palm image corresponding to the acquired image through reconstruction.

Specifically, when performing super-resolution reconstruction on the plurality of acquired images, the server assigns different contribution weights to the palm region of interest and the secondary region of interest, the contribution weight assigned to the palm region of interest being higher than the contribution weight assigned to the secondary region of interest, to obtain the image corresponding to the acquired image through reconstruction, and directly uses the image obtained through reconstruction as the palm image. When super-resolution reconstruction is performed on an acquired image in the plurality of acquired images, the server may pay more attention to the palm region of interest in the acquired image than to the secondary region of interest in the acquired image.

In an embodiment, as shown in FIG. 6, the server may input the acquired image to a pre-trained super-resolution model to determine the palm region of interest included in the palm region in the acquired image through the super-resolution model, and assign a higher contribution weight to the palm region of interest in the acquired image compared to the secondary region of interest when performing super-resolution reconstruction on an acquired image in the plurality of acquired images, to obtain and output the palm image corresponding to the acquired image. The super-resolution model is a neural network model configured for super-resolution reconstruction and has a capability of reconstructing a high-resolution palm image from the acquired image.

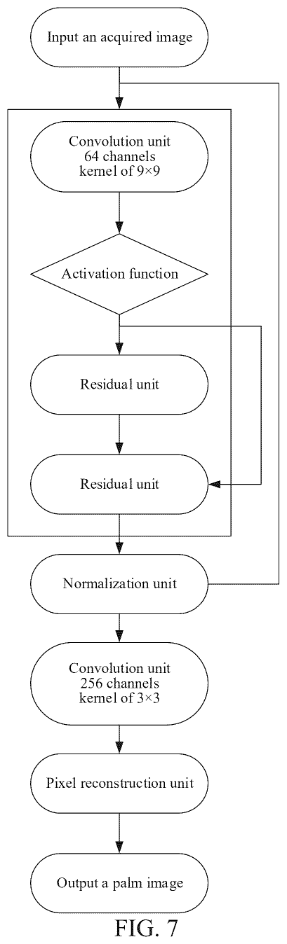

In an embodiment, as shown in FIG. 7, the super-resolution model may include a convolution unit with 64 channels and a kernel of 9×9, an activation function, a plurality of residual units, a normalization unit, a convolution unit with 256 channels and a kernel of 3×3, and a pixel reconstruction unit. The acquired image is inputted to the super-resolution model to perform super-resolution reconstruction so that a palm image having a resolution higher than that of the inputted acquired image may be outputted.

In the foregoing embodiment, for each acquired image, the palm region of interest and the secondary region of interest included in the palm region in the acquired image are determined. The palm region of interest of the acquired image has richer and more unique biological features than the secondary region of interest. Therefore, when super-resolution reconstruction is performed on the acquired image, different contribution weights are assigned to the palm region of interest and the secondary region of interest, the contribution weight assigned to the palm region of interest being higher than the contribution weight assigned to the secondary region of interest, to obtain the palm image corresponding to the acquired image through reconstruction, thereby further improving the resolution of the image, improving the accuracy of identity authentication, and avoiding the waste of hardware resources configured for supporting the identity authentication function.

In an embodiment, the assigning, when performing super-resolution reconstruction on the acquired image, different contribution weights to the palm region of interest and the secondary region of interest, a contribution weight assigned to the palm region of interest being higher than a contribution weight assigned to the secondary region of interest, to obtain the palm image corresponding to the acquired image through reconstruction includes: assigning, when performing super-resolution reconstruction on the acquired image, different contribution weights to the palm region of interest and the secondary region of interest, the contribution weight assigned to the palm region of interest being higher than the contribution weight assigned to the secondary region of interest, to obtain an initial palm image corresponding to the acquired image through reconstruction; determining an initial palm key region included in a palm region in the initial palm image, a palm part in the initial palm key region being related to an acquisition angle of the initial palm image; and performing local image enhancement on the initial palm key region based on the initial palm image to obtain a palm image corresponding to the initial palm image.

A region obtained after performing enhancement on the initial palm key region has more prominent texture details than the initial palm key region. The initial palm image is an image obtained after super-resolution reconstruction is performed on the acquired image and before local image enhancement is performed. The initial palm key region is a palm key region included in the palm region in the initial palm image.

Specifically, when performing super-resolution reconstruction on the acquired image, the server may assign different contribution weights to the palm region of interest and the secondary region of interest, the contribution weight assigned to the palm region of interest being higher than the contribution weight assigned to the secondary region of interest, to obtain the initial palm image corresponding to the acquired image through reconstruction. A resolution of the initial palm image is higher than a resolution of the acquired image corresponding to the palm image. The server may determine the initial palm key region included in the palm region in the initial palm image and perform local image enhancement on the initial palm key region based on the initial palm image to obtain the palm image corresponding to the initial palm image.

In an embodiment, for each of the plurality of acquired initial palm images, the server may extract an image feature of the initial palm image and position the initial palm key region included in the palm region in the initial palm image according to the extracted image feature.

In an embodiment, for each of the plurality of acquired initial palm images, the server may input the initial palm image to a pre-trained key region recognition model to extract the image feature of the initial palm image through the pre-trained key region recognition model, and position and output the initial palm key region included in the palm region in the initial palm image according to the extracted image feature.

In an embodiment, local image enhancement may be implemented in a local histogram equalization manner, or may be implemented in a local adaptive contrast enhancement manner.

In the foregoing embodiment, the initial palm key region included in the palm region in the initial palm image obtained after super-resolution reconstruction is determined, and local image enhancement is performed on the initial palm key region based on the initial palm image to obtain the palm image corresponding to the initial palm image. A region obtained after performing enhancement on the initial palm key region has more prominent texture details than the initial palm key region. Therefore, the image quality of the palm image is further improved, thereby further improving the accuracy of identity authentication and avoiding the waste of hardware resources configured for supporting the identity authentication function.

In an embodiment, the assigning, when performing super-resolution reconstruction on the acquired image, different contribution weights to the palm region of interest and the secondary region of interest, a contribution weight assigned to the palm region of interest being higher than a contribution weight assigned to the secondary region of interest, to obtain the palm image corresponding to the acquired image through reconstruction includes: assigning, when performing super-resolution reconstruction on the acquired image, different contribution weights to the palm region of interest and the secondary region of interest, the contribution weight assigned to the palm region of interest being higher than the contribution weight assigned to the secondary region of interest, to obtain a to-be-denoised palm image corresponding to the acquired image through reconstruction; determining noise distribution information of the to-be-denoised palm image based on the to-be-denoised palm image; extracting an image feature of the to-be-denoised palm image, and removing a noise feature from the image feature according to the noise distribution information to obtain an image structure feature; and performing image reconstruction based on the image structure feature to obtain a denoised palm image for the to-be-denoised palm image.

The to-be-denoised palm image is an image obtained after super-resolution reconstruction is performed on the acquired image and before denoising is performed. The noise feature is a feature of noise existing in the to-be-denoised palm image. The image structure feature is a feature configured for characterizing an image structure in the to-be-denoised palm image. The noise distribution information is information representing noise distribution in the to-be-denoised palm image. A pixel where noise is located may be detected, and a position of the pixel is recorded to obtain the noise distribution information.

Specifically, when performing super-resolution reconstruction on the acquired image, the server may assign different contribution weights to the palm region of interest and the secondary region of interest, the contribution weight assigned to the palm region of interest being higher than the contribution weight assigned to the secondary region of interest, to obtain the to-be-denoised palm image corresponding to the acquired image through reconstruction. A resolution of the to-be-denoised palm image is higher than a resolution of the acquired image corresponding to the palm image. The server may determine the noise distribution information of the to-be-denoised palm image based on the to-be-denoised palm image. The server may extract the image feature of the to-be-denoised palm image and remove the noise feature from the image feature according to the noise distribution information to obtain the image structure feature. Further, the server may perform image reconstruction based on the image structure feature to obtain the denoised palm image for the to-be-denoised palm image. Compared with the to-be-denoised palm image, the denoised palm image has less noise and better image quality.

In an embodiment, the server may input the to-be-denoised palm image to a pre-trained image denoising model to determine the noise distribution information of the to-be-denoised palm image based on the to-be-denoised palm image through the image denoising model, extract the image feature of the to-be-denoised palm image, remove the noise feature from the image feature according to the noise distribution information to obtain the image structure feature, and perform image reconstruction based on the image structure feature to obtain and output the denoised palm image for the to-be-denoised palm image.

In the foregoing embodiment, the noise distribution information of the to-be-denoised palm image is determined through the to-be-denoised palm image obtained through super-resolution reconstruction. Further, the image feature of the to-be-denoised palm image is extracted, and the noise feature is removed from the image feature according to the noise distribution information to obtain the image structure feature. In addition, image reconstruction is performed based on the image structure feature to obtain the denoised palm image for the to-be-denoised palm image, thereby further improving the image quality of the palm image, improving the accuracy of identity authentication, and avoiding the waste of hardware resources configured for supporting the identity authentication function.

In an embodiment, for each acquired image, the server may determine the palm region of interest included in the acquired image and determine the secondary region of interest except the palm region of interest in the palm region in the acquired image. The palm part in the palm region of interest is related to the acquisition angle of the acquired image. When performing super-resolution reconstruction on the acquired image, the server may assign different contribution weights to the palm region of interest and the secondary region of interest, the contribution weight assigned to the palm region of interest being higher than the contribution weight assigned to the secondary region of interest, to obtain the to-be-denoised palm image corresponding to the acquired image through reconstruction. The server may determine the noise distribution information of the to-be-denoised palm image based on the to-be-denoised palm image. The server may extract the image feature of the to-be-denoised palm image and remove the noise feature from the image feature according to the noise distribution information to obtain the image structure feature. The server may perform image reconstruction based on the image structure feature to obtain the denoised initial palm image for the to-be-denoised palm image. The server may determine the initial palm key region included in the palm region in the initial palm image. The palm part in the initial palm key region is related to the acquisition angle of the initial palm image. The server may perform local image enhancement on the initial palm key region based on the initial palm image to obtain the palm image corresponding to the initial palm image.

In an embodiment, for each acquired image, the server may determine the palm region of interest included in the palm region in the acquired image and determine the secondary region of interest except the palm region of interest in the palm region in the acquired image. The palm part in the palm region of interest is related to the acquisition angle of the acquired image. When performing super-resolution reconstruction on the acquired image, the server may assign different contribution weights to the palm region of interest and the secondary region of interest, the contribution weight assigned to the palm region of interest being higher than the contribution weight assigned to the secondary region of interest, to obtain the initial palm image corresponding to the acquired image through reconstruction. The server may determine the initial palm key region included in the palm region in the initial palm image. The palm part in the initial palm key region is related to the acquisition angle of the initial palm image. The server may perform local image enhancement on the initial palm key region based on the initial palm image to obtain the to-be-denoised palm image corresponding to the initial palm image. The server may determine the noise distribution information of the to-be-denoised palm image based on the to-be-denoised palm image. The server may extract the image feature of the to-be-denoised palm image and remove the noise feature from the image feature according to the noise distribution information to obtain the image structure feature. The server may perform image reconstruction based on the image structure feature to obtain the denoised palm image for the to-be-denoised palm image.

In an embodiment, the palm image is obtained by reconstruction through a pre-trained super-resolution model. The method further includes: acquiring at least one set of first palm image pairs, where the first palm image pair includes a first sample palm image and a reference palm image; the reference palm image has a higher resolution than a corresponding first sample palm image; the first sample palm image carries a first label of interest, and the first label of interest indicates a sample palm region of interest included in a palm region in the first sample palm image; a palm part in the sample palm region of interest is related to an acquisition angle of the first sample palm image; the palm region in the first sample palm image further includes a sample secondary region of interest except the sample palm region of interest; and the first label of interest is configured for indicating that when super-resolution reconstruction is performed on the first sample palm image, different contribution weights are assigned to the sample palm region of interest and the sample secondary region of interest, and a contribution weight assigned to the sample palm region of interest is higher than a contribution weight assigned to the sample secondary region of interest; inputting the first sample palm image to a to-be-trained super-resolution model to obtain a reconstructed palm image; and training the to-be-trained super-resolution model according to a difference between the reconstructed palm image and a corresponding reference palm image to obtain a trained super-resolution model.

The first palm image pair is a palm image pair configured for training the to-be-trained super-resolution model. The sample palm region of interest is a palm region of interest included in the palm region in the first sample palm image. The sample secondary region of interest is a secondary region of interest included in the palm region in the first sample palm image.

Specifically, the server may acquire at least one set of first palm image pairs, and input the first sample palm image in the first palm image pair to the to-be-trained super-resolution model to obtain the reconstructed palm image. Further, the server may perform iterative training on the to-be-trained super-resolution model according to the difference between the reconstructed palm image and the corresponding reference palm image in the first palm image pair, and the iterative training is stopped until an iteration stopping condition is satisfied, to obtain the trained super-resolution model.

In an embodiment, the iteration stopping condition may be that the number of iterations reaches a preset number of iterations, or may be that the difference between the reconstructed palm image and the corresponding reference palm image in the first palm image pair is less than a preset difference threshold.

In the foregoing embodiment, the first sample palm image is inputted to the to-be-trained super-resolution model to obtain the reconstructed palm image, and the to-be-trained super-resolution model is trained according to the difference between the reconstructed palm image and the corresponding reference palm image to obtain a trained super-resolution model having a strong resolution reconstruction capability. Further, the acquired image is reconstructed based on the super-resolution model to obtain the palm image, thereby further improving the resolution of the image, improving the accuracy of identity authentication, and avoiding the waste of hardware resources configured for supporting the identity authentication function.

In an embodiment, the single-angle palm feature is obtained by extraction through a pre-trained feature extraction model. The method further includes: acquiring at least one set of second palm image pairs, where the second palm image pair includes a label palm image and a second sample palm image; the label palm image carries a second label of interest, and the second label of interest indicates a sample palm key region included in a palm region in the label palm image; a palm part in the sample palm key region is related to an acquisition angle of the label palm image; and the second label of interest is configured for indicating that when feature extraction is performed on the label palm image, different contribution weights are assigned to the sample palm key region and a sample auxiliary region, and a contribution weight assigned to the sample palm key region is higher than a contribution weight assigned to the sample auxiliary region; inputting the label palm image to a to-be-trained feature extraction model to obtain a reference single-angle palm feature through extraction; inputting the second sample palm image to the to-be-trained feature extraction model to obtain a predicted single-angle palm feature through extraction; and training the to-be-trained feature extraction model according to a difference between the predicted single-angle palm feature and a corresponding reference single-angle palm feature to obtain a trained feature extraction model.

The second palm image pair is a palm image pair configured for training the to-be-trained feature extraction model. The sample palm key region is a palm key region included in the palm region in the second sample palm image. The sample auxiliary region is an auxiliary region included in the palm region in the second sample palm image.

Specifically, the server may acquire at least one set of second palm image pairs, and input the label palm image in the second palm image pair to the to-be-trained feature extraction model to obtain the reference single-angle palm feature through extraction. The server may input the second sample palm image to the to-be-trained feature extraction model to obtain the predicted single-angle palm feature through extraction. The server may perform iterative training on the to-be-trained feature extraction model according to the difference between the predicted single-angle palm feature and the corresponding reference single-angle palm feature, and the iterative training is stopped until an iteration stopping condition is satisfied, to obtain the trained feature extraction model.

In an embodiment, the iteration stopping condition may be that the number of iterations reaches a preset number of iterations, or may be that the difference between the predicted single-angle palm feature and the corresponding reference single-angle palm feature is less than a preset difference threshold.

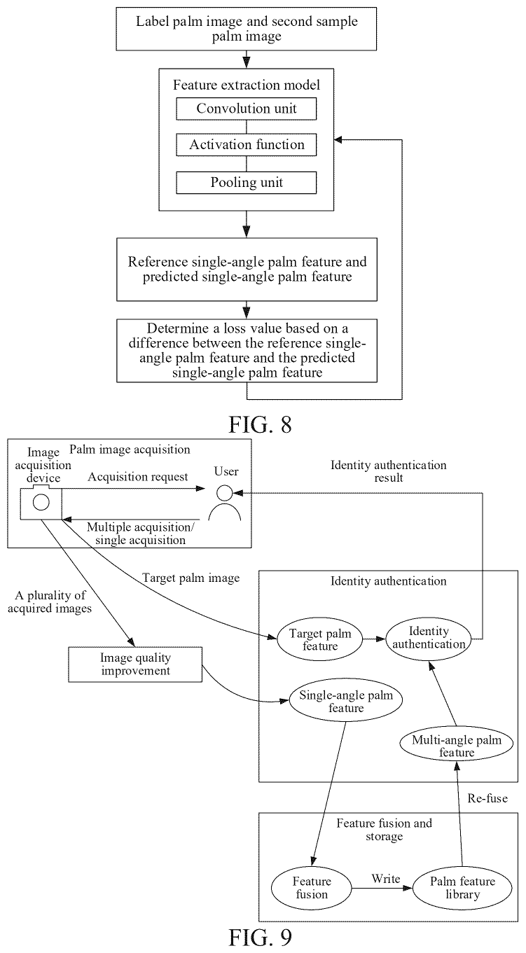

In an embodiment, as shown in FIG. 8, the feature extraction model includes a convolution unit, an activation function, and a pooling unit. The server may input the label palm image in the second palm image pair to the to-be-trained feature extraction model to obtain the reference single-angle palm feature through extraction. In addition, the server may further input the second sample palm image to the to-be-trained feature extraction model to obtain the predicted single-angle palm feature through extraction. Further, the server may determine a loss value according to the difference between the predicted single-angle palm feature and the corresponding reference single-angle palm feature and perform iterative training on the to-be-trained feature extraction model according to the loss value, and the iterative training is stopped until an iteration stopping condition is satisfied, to obtain the trained feature extraction model.

In an embodiment, the server may perform data enhancement on the label palm image and the second sample palm image in the second palm image pair and use the enhanced image as training data to train the to-be-trained feature extraction model. For example, the data enhancement manner may specifically include at least one of rotation, translation, zooming, or the like. The diversity of the training data may be increased, a training data set may be expanded, and a generalization capability of the model may be improved.

In an embodiment, the server may perform data preprocessing on the label palm image and the second sample palm image in the second palm image pair and use the preprocessed image as training data to train the to-be-trained feature extraction model. For example, the data preprocessing manner may specifically include at least one of grayscale conversion, histogram equalization, or the like. The impact of light, noise, and the like on the image quality may be reduced.

In the foregoing embodiment, the label palm image is inputted to the to-be-trained feature extraction model to obtain the reference single-angle palm feature through extraction, and the second sample palm image is inputted to the to-be-trained feature extraction model to obtain the predicted single-angle palm feature through extraction. Further, the to-be-trained feature extraction model is trained according to the difference between the predicted single-angle palm feature and the corresponding reference single-angle palm feature to obtain the trained feature extraction model having a capability of accurately improving the image feature, thereby further improving the accuracy of identity authentication and avoiding the waste of hardware resources configured for supporting the identity authentication function.

In an embodiment, the fusing single-angle palm features of the plurality of palm images to obtain a multi-angle palm feature of the palm includes: determining the acquisition angles corresponding to the plurality of palm images; assigning, according to the acquisition angles corresponding to the plurality of palm images, respective fusion weights to the single-angle palm features corresponding to the plurality of palm images; and fusing the single-angle palm features of the plurality of palm images according to the respective fusion weights of the single-angle palm features corresponding to the plurality of palm images to obtain the multi-angle palm feature of the palm.

In an embodiment, the server may input the plurality of palm images to a pre-trained image angle recognition model to recognize and output acquisition angles corresponding to the plurality of palm images through the image angle recognition model.

In an embodiment, the server may determine the acquisition angles corresponding to the plurality of palm images and assign, according to the acquisition angles corresponding to the plurality of palm images, respective fusion weights to the single-angle palm features corresponding to the plurality of palm images. The server may perform weighted fusion on the single-angle palm features of the plurality of palm images according to the respective fusion weights of the single-angle palm features corresponding to the plurality of palm images to obtain the multi-angle palm feature of the palm.

In an embodiment, the server may determine the acquisition angles corresponding to the plurality of palm images and assign, according to the acquisition angles corresponding to the plurality of palm images, respective fusion weights to the single-angle palm features corresponding to the plurality of palm images. The server may perform feature cascading on the single-angle palm features of the plurality of palm images according to the respective fusion weights of the single-angle palm features corresponding to the plurality of palm images to obtain the multi-angle palm feature of the palm.

In an embodiment, the server may determine the acquisition angles corresponding to the plurality of palm images and assign, according to the acquisition angles corresponding to the plurality of palm images, respective fusion weights to the single-angle palm features corresponding to the plurality of palm images. The server may select the multi-angle palm feature of the palm from the single-angle palm features of the plurality of palm images according to the respective fusion weights of the single-angle palm features corresponding to the plurality of palm images.

In the foregoing embodiment, since the palm images acquired at different acquisition angles contain feature information with different richness, respective fusion weights may be assigned to the single-angle palm features corresponding to the plurality of palm images according to the acquisition angles corresponding to the plurality of palm images, and the single-angle palm features of the plurality of palm images are fused according to the respective fusion weights of the single-angle palm features corresponding to the plurality of palm images to obtain the multi-angle palm feature of the palm so that a more accurate and richer multi-angle palm feature may be acquired, thereby further improving the accuracy of identity authentication and avoiding the waste of hardware resources configured for supporting the identity authentication function.

In an embodiment, the multi-angle palm feature is obtained by fusing the single-angle palm features of the plurality of palm images in a target fusion manner. The method further includes: acquiring a plurality of test palm images and first reference categories to which the test palm images belong, the plurality of test palm images being acquired for different test palms at different acquisition angles; determining, based on test palm images obtained by acquiring the same test palm at different acquisition angles, test single-angle palm features of the same test palm at different acquisition angles; determining multiple candidate fusion manners; fusing, for each candidate fusion manner, the test single-angle palm features of the same test palm at different acquisition angles according to the candidate fusion manner to obtain a test multi-angle palm feature corresponding to the candidate fusion manner; inputting the test palm image and the test multi-angle palm feature to a pre-trained palm classification model to perform category prediction on the test palm image through the pre-trained palm classification model based on the test multi-angle palm feature to obtain a first predicted category to which the test palm image belongs corresponding to the candidate fusion manner; and determining the target fusion manner from the multiple candidate fusion manners according to differences between first predicted categories corresponding to the candidate fusion manners and the first reference categories.

The first reference category is a category to which the test palm image belongs, and the first reference category to which each test palm image belongs may refer to a test palm acquired corresponding to each test palm image. One palm may be used as one category, and the plurality of palm images obtained by acquiring the same palm at different acquisition angles belong to the same category.

Specifically, the server may acquire the plurality of test palm images and the first reference categories to which the test palm images belong. The server may perform feature extraction on the test palm images obtained by acquiring the same test palm at different acquisition angles to obtain the test single-angle palm features of the same test palm at different acquisition angles. The server may acquire the multiple candidate fusion manners. For each candidate fusion manner, the server may fuse the test single-angle palm features of the same test palm at different acquisition angles according to the candidate fusion manner to obtain a test multi-angle palm feature corresponding to the candidate fusion manner. The server may input the test palm image and the test multi-angle palm feature corresponding to the candidate fusion manner to the pre-trained palm classification model to perform category prediction on the test palm image through the pre-trained palm classification model based on the test multi-angle palm feature to obtain the first predicted category to which the test palm image belongs corresponding to the candidate fusion manner. The server may determine the target fusion manner from the multiple candidate fusion manners according to the differences between the first predicted categories corresponding to the candidate fusion manners and the respective first reference categories. Further, the server may fuse the single-angle palm features of the plurality of palm images in the target fusion manner to obtain the multi-angle palm feature.

In the foregoing embodiment, the multiple candidate fusion manners are traversed, the target fusion manner with the best fusion effect is selected from the multiple candidate fusion manners, and then the single-angle palm features of the plurality of palm images are fused in the target fusion manner so that a more accurate and richer multi-angle palm feature may be obtained, thereby further improving the accuracy of identity authentication and avoiding the waste of hardware resources configured for supporting the identity authentication function.

In an embodiment, the method further includes: acquiring at least one third sample palm image and a second reference category to which the third sample palm image belongs, third sample palm images being acquired for different sample palms at different acquisition angles; determining, based on third sample palm images obtained by acquiring the same sample palm at different acquisition angles, sample single-angle palm features of the same sample palm at different acquisition angles; fusing the sample single-angle palm features of the same sample palm at different acquisition angles to obtain a sample multi-angle palm feature of the sample palm; inputting the third sample palm image and the sample multi-angle palm feature to a to-be-trained palm classification model to perform category prediction on the third sample palm image through the to-be-trained palm classification model based on the sample multi-angle palm feature to obtain a second predicted category to which the third sample palm image belongs; and training the to-be-trained palm classification model according to a difference between the second predicted category and the second reference category to obtain a trained palm classification model.

The second reference category is a category to which the third sample palm image belongs, and the second reference category to which each third sample palm image belongs may refer to a sample palm acquired corresponding to each third sample palm image.

Specifically, the server may acquire at least one third sample palm image and the second reference category to which the third sample palm image belongs. The server may perform feature extraction on the third sample palm images obtained by acquiring the same sample palm at different acquisition angles to obtain the sample single-angle palm features of the same sample palm at different acquisition angles. The server may fuse the sample single-angle palm features of the same sample palm at different acquisition angles to obtain the sample multi-angle palm feature of the sample palm. Further, the server may input the third sample palm image and the sample multi-angle palm feature to the to-be-trained palm classification model to perform category prediction on the third sample palm image through the to-be-trained palm classification model based on the sample multi-angle palm feature to obtain the second predicted category to which the third sample palm image belongs. The server may perform iterative training on the to-be-trained palm classification model according to the difference between the second predicted category and the second reference category, and the iterative training is stopped until an iteration stopping condition is satisfied, to obtain the trained palm classification model.

In an embodiment, the iteration stopping condition may be that the number of iterations reaches a preset number of iterations, or may be that the difference between the second predicted category and the second reference category is less than a preset difference threshold.

In the foregoing embodiment, the third sample palm image and the sample multi-angle palm feature are inputted to the to-be-trained palm classification model to perform category prediction on the third sample palm image through the to-be-trained palm classification model based on the sample multi-angle palm feature to obtain the second predicted category to which the third sample palm image belongs. In addition, the to-be-trained palm classification model is trained according to the difference between the second predicted category and the second reference category to which the third sample palm image belongs, so that a trained palm classification model having a strong classification function may be obtained. Further, a more appropriate target fusion manner may be determined from the multiple candidate fusion manners through the palm classification model, thereby further improving the accuracy of identity authentication and avoiding the waste of hardware resources configured for supporting the identity authentication function.

In an embodiment, the multi-angle palm feature and a user identity identifier of a user to which the palm belongs are associatively stored in a palm feature library. The method further includes: acquiring a to-be-recognized target palm image, and performing palm feature extraction on the to-be-recognized target palm image to obtain a target palm feature; searching multi-angle palm features stored in the palm feature library for a target multi-angle palm feature that satisfies a similarity condition with the target palm feature; and determining, when the target multi-angle palm feature is found, an identity authentication result according to a user identity identifier associated with the target multi-angle palm feature.

The user identity identifier is a character string configured for uniquely identifying a user identity. The target palm image is a palm image to be recognized and authenticated that is acquired in an identity authentication scene.

Specifically, in the identity authentication scene, the terminal may acquire, through a locally deployed image acquisition device, a target palm image to be recognized and authenticated, and transmit the target palm image to the server. The server may receive the target palm image transmitted by the terminal, perform palm feature extraction on the target palm image to obtain the target palm feature, and search the multi-angle palm features stored in the palm feature library for the target multi-angle palm feature that satisfies the similarity condition with the target palm feature. When the target multi-angle palm feature is found, the server may generate the identity authentication result according to the user identity identifier associated with the target multi-angle palm feature. The identity authentication result includes that identity authentication succeeds and identity authentication fails.

In an embodiment, the searching multi-angle palm features stored in the palm feature library for a target multi-angle palm feature that satisfies a similarity condition with the target palm feature includes: searching the multi-angle palm features stored in the palm feature library for a multi-angle palm feature having the maximum similarity with the target palm feature, and using the multi-angle palm feature as the target multi-angle palm feature.

In an embodiment, as shown in FIG. 9, in a scene of palm-based identity authentication, a processing process is mainly divided into two stages. A first stage is a palm feature processing stage, and a second stage is an authentication stage. Specifically, for the first stage, the server may acquire acquired images of the same palm at different acquisition angles transmitted by the terminal. For the acquired images, the server may perform image quality improvement on the acquired images to obtain a plurality of high-quality palm images. An image quality improvement manner may include at least one of super-resolution reconstruction, local image enhancement, denoising, or the like. For each palm image, the server may position a palm key region included in a palm region in the palm image, perform feature extraction on the palm image, and assign different contribution weights to the palm key region and an auxiliary region in the palm image during feature extraction to obtain a single-angle palm feature of the palm image. A contribution weight assigned to the palm key region in the palm image is higher than a contribution weight assigned to the auxiliary region in the palm image. Further, the server may fuse single-angle palm features of the plurality of palm images to obtain the multi-angle palm feature of the palm, and associatively store the multi-angle palm feature and a user identity identifier of a user to which the palm belongs in a palm feature library. For the second stage, the terminal may acquire, through a locally deployed image acquisition device, a target palm image to be recognized and authenticated, and transmit the target palm image to the server. The server may receive the target palm image transmitted by the terminal, perform palm feature extraction on the target palm image to obtain a target palm feature, and search multi-angle palm features stored in the palm feature library for a target multi-angle palm feature that satisfies a similarity condition with the target palm feature. When the target multi-angle palm feature is found, the server may generate an identity authentication result according to a user identity identifier associated with the target multi-angle palm feature and return the identity authentication result to the terminal.

In the foregoing embodiment, palm feature extraction is performed on the to-be-recognized target palm image to obtain the target palm feature, and the multi-angle palm features stored in the palm feature library are searched for the target multi-angle palm feature that satisfies the similarity condition with the target palm feature. When the target multi-angle palm feature is found, the identity authentication result is determined according to the user identity identifier associated with the target multi-angle palm feature, thereby further improving the accuracy of identity authentication and avoiding the waste of hardware resources configured for supporting an identity authentication function.

In an embodiment, the multi-angle palm feature is obtained by fusing the single-angle palm features of the plurality of palm images according to a predetermined target fusion manner; and the single-angle palm features of the plurality of palm images and the multi-angle palm feature are associatively stored in the palm feature library. The method further includes: re-fusing, when the target fusion manner is updated, the single-angle palm features associated with the plurality of palm images in the palm feature library according to an updated fusion manner to obtain a re-fused multi-angle palm feature of the palm; and updating the multi-angle palm feature in the palm feature library to the re-fused multi-angle palm feature.

Specifically, the server may monitor the fusion manner. When it is monitored that the target fusion manner is updated, the server may re-fuse the single-angle palm features associated with the plurality of palm images in the palm feature library according to the updated fusion manner to obtain the re-fused multi-angle palm feature of the palm. Further, the server may update the multi-angle palm feature stored in the palm feature library to the re-fused multi-angle palm feature.

The multi-angle palm feature and the user identity identifier of the user to which the palm belongs are associatively stored in the palm feature library, and the single-angle palm features of the plurality of palm images and the multi-angle palm feature are associatively stored in the palm feature library. Therefore, it may be learned that the single-angle palm features of the plurality of palm images, the multi-angle palm feature, and the user identity identifier of the user to which the palm belongs are associatively stored in the palm feature library.

In an embodiment, the server may use the user identity identifier of the user to which the palm belongs as a key, use the single-angle palm features of the plurality of corresponding palm images and the multi-angle palm feature as values, and associatively store them in the palm feature library in the form of key-value pairs.

In an embodiment, the server may use the user identity identifier of the user to which the palm belongs as a key, use results obtained after compressing the single-angle palm features of the plurality of corresponding palm images and the multi-angle palm feature as values, and associatively store them in the palm feature library in the form of key-value pairs.

In an embodiment, the server may search, using an indexing technology through the user identity identifier of the user to which the palm belongs, the palm feature library for the results obtained after compressing the single-angle palm features of the plurality of associated palm images and the multi-angle palm feature, and decompress the compressed results to obtain the single-angle palm features of the plurality of palm images and the multi-angle palm feature.

In the foregoing embodiment, when the target fusion manner is updated, the single-angle palm features associated with the plurality of palm images in the palm feature library are re-fused according to a better updated fusion manner to obtain the re-fused multi-angle palm feature of the palm, and the multi-angle palm feature in the palm feature library is updated to the re-fused multi-angle palm feature. Further, identity authentication is performed based on the re-fused multi-angle palm feature having richer characteristic information, thereby further improving the accuracy of identity authentication and avoiding the waste of hardware resources configured for supporting the identity authentication function.

In an embodiment, the image acquisition device involved in this application may include a camera, an optical element, an image sensor, a control system, and a data interface. The camera is responsible for capturing palm images at different acquisition angles and needs to have sufficient field of view range and flexibility to capture clear palm images at different acquisition angles. The optical element includes a lens and an aperture and is configured to clearly image the palm at different acquisition angles. The image sensor is responsible for converting optical imaging into a digital image and needs to have a high resolution, high sensitivity, and a wide dynamic range to acquire clear palm images under various lighting conditions. The control system is responsible for controlling a working state of the camera, an optical imaging parameter of the optical element, and settings of the image sensor. The control system may support automatic or manual adjustment to obtain optimum image quality under different acquisition angles and light conditions. The data interface is responsible for transmitting acquired palm image data and needs to have sufficient bandwidth and low delay to transmit the palm image in time.

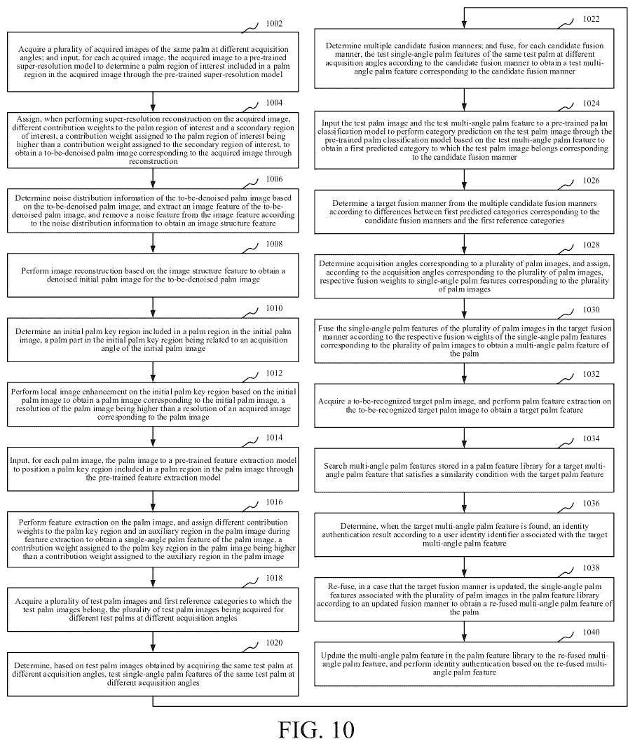

As shown in FIG. 10, in an embodiment, a palm feature processing method for identity authentication is provided. In this embodiment, an example in which the method is applied to the server 104 in FIG. 1 is used for description. The method specifically includes the following operations.

Operation 1002: Acquire a plurality of acquired images of the same palm at different acquisition angles; and input, for each acquired image, the acquired image to a pre-trained super-resolution model to determine a palm region of interest included in a palm region in the acquired image through the pre-trained super-resolution model.

A palm part in the palm region of interest is related to the acquisition angle of the acquired image. The palm region in the acquired image further includes a secondary region of interest except the palm region of interest.

Operation 1004: Assign, when performing super-resolution reconstruction on the acquired image, different contribution weights to the palm region of interest and the secondary region of interest, a contribution weight assigned to the palm region of interest being higher than a contribution weight assigned to the secondary region of interest, to obtain a to-be-denoised palm image corresponding to the acquired image through reconstruction.

Operation 1006: Determine noise distribution information of the to-be-denoised palm image based on the to-be-denoised palm image; and extract an image feature of the to-be-denoised palm image, and remove a noise feature from the image feature according to the noise distribution information to obtain an image structure feature.

Operation 1008: Perform image reconstruction based on the image structure feature to obtain a denoised initial palm image for the to-be-denoised palm image.

Operation 1010: Determine an initial palm key region included in a palm region in the initial palm image, a palm part in the initial palm key region being related to an acquisition angle of the initial palm image.

Operation 1012: Perform local image enhancement on the initial palm key region based on the initial palm image to obtain a palm image corresponding to the initial palm image, a resolution of the palm image being higher than a resolution of an acquired image corresponding to the palm image.

Operation 1014: Input, for each palm image, the palm image to a pre-trained feature extraction model to position a palm key region included in a palm region in the palm image through the pre-trained feature extraction model.

A palm part in the palm key region is related to an acquisition angle of the palm image. The palm image further includes an auxiliary region except the palm key region.

Operation 1016: Perform feature extraction on the palm image, and assign different contribution weights to the palm key region and the auxiliary region in the palm image during feature extraction to obtain a single-angle palm feature of the palm image, a contribution weight assigned to the palm key region in the palm image being higher than a contribution weight assigned to the auxiliary region in the palm image.

Operation 1018: Acquire a plurality of test palm images and first reference categories to which the test palm images belong, the plurality of test palm images being acquired for different test palms at different acquisition angles.

Operation 1020: Determine, based on test palm images obtained by acquiring the same test palm at different acquisition angles, test single-angle palm features of the same test palm at different acquisition angles.

Operation 1022: Determine multiple candidate fusion manners; and fuse, for each candidate fusion manner, the test single-angle palm features of the same test palm at different acquisition angles according to the candidate fusion manner to obtain a test multi-angle palm feature corresponding to the candidate fusion manner.

Operation 1024: Input the test palm image and the test multi-angle palm feature to a pre-trained palm classification model to perform category prediction on the test palm image through the pre-trained palm classification model based on the test multi-angle palm feature to obtain a first predicted category to which the test palm image belongs corresponding to the candidate fusion manner.

Operation 1026: Determine a target fusion manner from the multiple candidate fusion manners according to differences between first predicted categories corresponding to the candidate fusion manners and the first reference categories.

Operation 1028: Determine acquisition angles corresponding to a plurality of palm images, and assign, according to the acquisition angles corresponding to the plurality of palm images, respective fusion weights to single-angle palm features corresponding to the plurality of palm images.

Operation 1030: Fuse the single-angle palm features of the plurality of palm images in the target fusion manner according to the respective fusion weights of the single-angle palm features corresponding to the plurality of palm images to obtain a multi-angle palm feature of the palm.

The single-angle palm features of the plurality of palm images, the multi-angle palm feature, and a user identity identifier of a user to which the palm belongs are associatively stored in a palm feature library.

Operation 1032: Acquire a to-be-recognized target palm image, and perform palm feature extraction on the to-be-recognized target palm image to obtain a target palm feature.

Operation 1034: Search multi-angle palm features stored in the palm feature library for a target multi-angle palm feature that satisfies a similarity condition with the target palm feature.

Operation 1036: Determine, when the target multi-angle palm feature is found, an identity authentication result according to a user identity identifier associated with the target multi-angle palm feature.

Operation 1038: Re-fuse, when the target fusion manner is updated, the single-angle palm features associated with the plurality of palm images in the palm feature library according to an updated fusion manner to obtain a re-fused multi-angle palm feature of the palm.

Operation 1040: Update the multi-angle palm feature in the palm feature library to the re-fused multi-angle palm feature, and perform identity authentication based on the re-fused multi-angle palm feature.

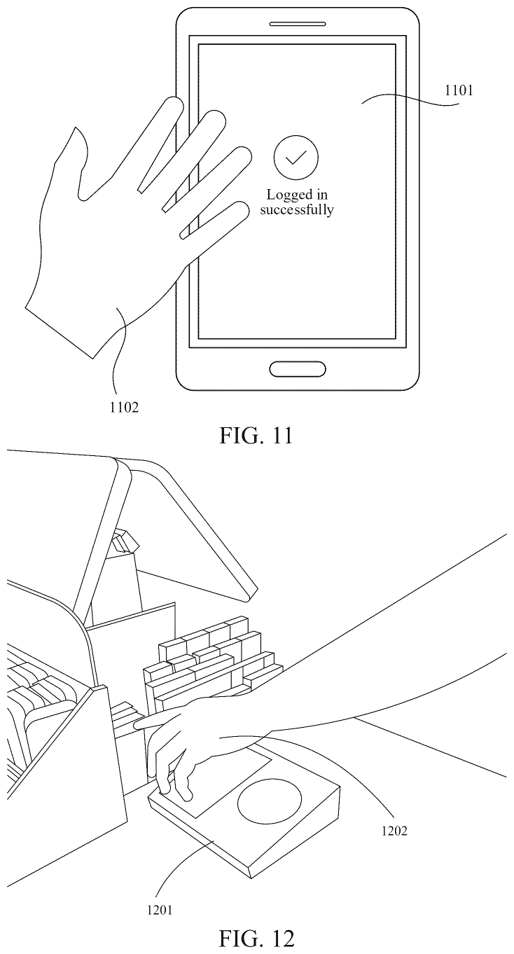

This application further provides an application scene that applies the foregoing palm feature processing method for identity authentication. Specifically, as shown in FIG. 11, the palm feature processing method for identity authentication may be applied to a scene in which identity authentication is performed using a palm to log in to an instant messaging application. The user identity identifier in this application includes an application login identifier configured for logging in to the instant messaging application, and the multi-angle palm feature is configured for performing identity authentication when the instant messaging application is logged in to, so as to automatically log in to the instant messaging application after palm authentication succeeds, without manually inputting the application login identifier to realize the login of the instant messaging application.

Specifically, the server may acquire a plurality of acquired images of the same palm at different acquisition angles; input, for each acquired image, the acquired image to a pre-trained super-resolution model to determine a palm region of interest included in a palm region in the acquired image through the pre-trained super-resolution model, and determine a secondary region of interest except the palm region of interest in the palm region in the acquired image, a palm part in the palm region of interest being related to the acquisition angle of the acquired image; and assign, when performing super-resolution reconstruction on the acquired image, different contribution weights to the palm region of interest and the secondary region of interest, a contribution weight assigned to the palm region of interest being higher than a contribution weight assigned to the secondary region of interest, to obtain a to-be-denoised palm image corresponding to the acquired image through reconstruction.

The server may determine noise distribution information of the to-be-denoised palm image based on the to-be-denoised palm image; extract an image feature of the to-be-denoised palm image, and remove a noise feature from the image feature according to the noise distribution information to obtain an image structure feature; perform image reconstruction based on the image structure feature to obtain a denoised initial palm image for the to-be-denoised palm image; determine an initial palm key region included in a palm region in the initial palm image, a palm part in the initial palm key region being related to an acquisition angle of the initial palm image; and perform local image enhancement on the initial palm key region based on the initial palm image to obtain a palm image corresponding to the initial palm image, a resolution of the palm image being higher than a resolution of the acquired image corresponding to the palm image.

For each palm image, the server may input the palm image to a pre-trained feature extraction model to position a palm key region included in a palm region in the palm image through the pre-trained feature extraction model and determine an auxiliary region except the palm key region in the palm region, a palm part in the palm key region being related to the acquisition angle of the palm image; and perform feature extraction on the palm image, and assign different contribution weights to the palm key region and the auxiliary region in the palm image during feature extraction to obtain a single-angle palm feature of the palm image. A contribution weight assigned to the palm key region in the palm image is higher than a contribution weight assigned to the auxiliary region in the palm image.

The server may acquire a plurality of test palm images and first reference categories to which the test palm images belong, the plurality of test palm images being acquired for different test palms at different acquisition angles; determine, based on test palm images obtained by acquiring the same test palm at different acquisition angles, test single-angle palm features of the same test palm at different acquisition angles; determine multiple candidate fusion manners; fuse, for each candidate fusion manner, the test single-angle palm features of the same test palm at different acquisition angles according to the candidate fusion manner to obtain a test multi-angle palm feature corresponding to the candidate fusion manner; input the test palm image and the test multi-angle palm feature to a pre-trained palm classification model to perform category prediction on the test palm image through the pre-trained palm classification model based on the test multi-angle palm feature to obtain a first predicted category to which the test palm image belongs corresponding to the candidate fusion manner; and determine the target fusion manner from the multiple candidate fusion manners according to differences between first predicted categories corresponding to the candidate fusion manners and the first reference categories.

The server may determine the acquisition angles corresponding to the plurality of palm images; assign, according to the acquisition angles corresponding to the plurality of palm images, respective fusion weights to the single-angle palm features corresponding to the plurality of palm images; fuse the single-angle palm features of the plurality of palm images in a target fusion manner according to the respective fusion weights of the single-angle palm features corresponding to the plurality of palm images to obtain the multi-angle palm feature of the palm; and The single-angle palm features of the plurality of palm images, the multi-angle palm feature, and the application login identifier of the user to which the palm belongs are associatively stored in a palm feature library.

Still referring to FIG. 11, an instant messaging application runs on a terminal 1101, and the user may place a target palm 1102 above an image acquisition device of the terminal 1101 to acquire a to-be-recognized target palm image. The terminal 1101 may transmit the to-be-recognized target palm image to a server. The server may receive the to-be-recognized target palm image and perform palm feature extraction on the to-be-recognized target palm image to obtain a target palm feature; and search multi-angle palm features stored in the palm feature library for a target multi-angle palm feature that satisfies a similarity condition with the target palm feature. When the target multi-angle palm feature is found, an identity authentication result is determined according to the application login identifier associated with the target multi-angle palm feature. After the identity authentication result indicates that palm authentication succeeds, the instant messaging application is automatically logged in to, without manually inputting the application login identifier to realize the login of the instant messaging application.

In this way, a plurality of palm images of the same palm at different acquisition angles are acquired, and a palm key region of the palm image is positioned so that more attention is paid to the palm key region during feature extraction to extract a single-angle palm feature of the palm image that is more accurately positioned. Further, single-angle palm features of the palm images are fused into a richer and more accurate multi-angle palm feature, and identity authentication is performed during the login of the instant messaging application based on the richer and more accurate multi-angle palm feature so that the accuracy of identity authentication for the login of the instant messaging application may be improved, thereby improving the palm authentication login efficiency of the instant messaging application and avoiding the waste of hardware resources configured for supporting an identity authentication function for the login of the instant messaging application.

This application further provides another application scene that applies the foregoing palm feature processing method for identity authentication. Specifically, as shown in FIG. 12, the palm feature processing method for identity authentication may be applied to a scene in which identity authentication is performed using a palm to realize resource transfer. The user identity identifier in this application includes a resource transfer identifier configured for resource transfer, and the multi-angle palm feature is configured for performing identity authentication during resource transfer to automatically transfer the resource after palm authentication succeeds, without manually inputting the resource transfer identifier to realize resource transfer. Specifically, a plurality of palm images of the same palm at different acquisition angles are acquired, and a palm key region of the palm image is positioned so that more attention is paid to the palm key region during feature extraction to extract a single-angle palm feature of the palm image that is more accurately positioned. Further, single-angle palm features of the palm images are fused into a richer and more accurate multi-angle palm feature. Still referring to FIG. 12, an image acquisition device is provided on a terminal 1201. The user may place a target palm 1202 within a field of view range of the image acquisition device of the terminal 1201 to acquire a to-be-recognized target palm image. The terminal 1201 may transmit the to-be-recognized target palm image to a server, and the server may perform identity authentication based on the target palm image and a richer and more accurate multi-angle palm feature during resource transfer so that the accuracy of identity authentication for resource transfer may be improved, thereby improving the efficiency of resource transfer and avoiding the waste of hardware resources configured for supporting an identity authentication function for resource transfer.

Although various operations in the flowcharts of the foregoing embodiments are shown sequentially, these operations are not necessarily performed sequentially. These operations are performed in no strict order unless explicitly stated herein, and these operations may be performed in other orders. Moreover, at least some of the steps in the foregoing embodiments may include a plurality of sub-steps or a plurality of stages. The sub-steps or stages are not necessarily performed at the same moment but may be performed at different moments. The sub-steps or stages are not necessarily sequentially performed, but may be performed alternately with other steps or at least some of sub-steps or stages of other steps.

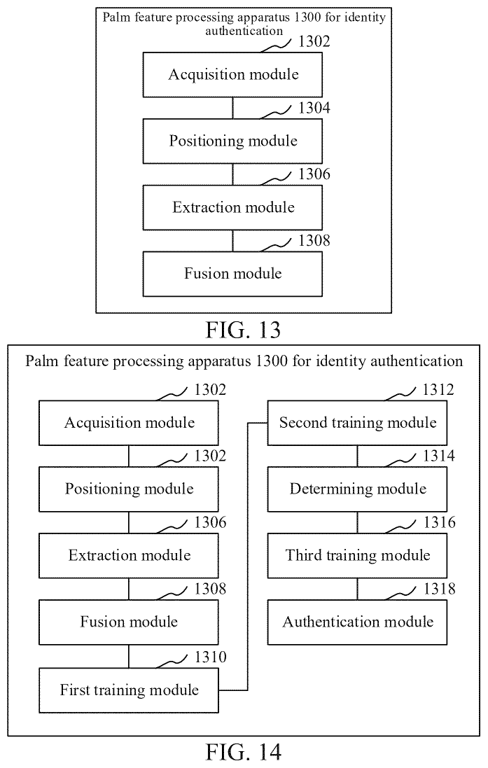

In an embodiment, as shown in FIG. 13, a palm feature processing apparatus 1300 for identity authentication is provided, specifically including:
an acquisition module 1302 configured to acquire a plurality of palm images of the same palm at different acquisition angles, a region occupied by a palm in each palm image forming a palm region;
a positioning module 1304 configured to position, for each palm image, a palm key region included in the palm region in the palm image, and determine an auxiliary region except the palm key region in the palm region, a palm part in the palm key region being related to the acquisition angle of the palm image;
an extraction module 1306 configured to perform feature extraction on the palm image, and assign different contribution weights to the palm key region and the auxiliary region in the palm image during feature extraction to obtain a single-angle palm feature of the palm image, a contribution weight assigned to the palm key region in the palm image being higher than a contribution weight assigned to the auxiliary region in the palm image; and
a fusion module 1308 configured to fuse single-angle palm features of the plurality of palm images to obtain a multi-angle palm feature of the palm, the multi-angle palm feature being configured for identity authentication.

In an embodiment, the acquisition module 1302 is further configured to: acquire a plurality of acquired images of the same palm at different acquisition angles; and perform super-resolution reconstruction on the plurality of acquired images to correspondingly obtain the plurality of palm images, a resolution of the palm image being higher than a resolution of the acquired image corresponding to the palm image.

In an embodiment, the acquisition module 1302 is further configured to: determine, for each acquired image, a palm region of interest included in a palm region in the acquired image, and determine a secondary region of interest except the palm region of interest in the palm region in the acquired image, a palm part in the palm region of interest being related to the acquisition angle of the acquired image; and assign, when performing super-resolution reconstruction on the acquired image, different contribution weights to the palm region of interest and the secondary region of interest, a contribution weight assigned to the palm region of interest being higher than a contribution weight assigned to the secondary region of interest, to obtain the palm image corresponding to the acquired image through reconstruction.

In an embodiment, the acquisition module 1302 is further configured to: assign, when performing super-resolution reconstruction on the acquired image, different contribution weights to the palm region of interest and the secondary region of interest, the contribution weight assigned to the palm region of interest being higher than the contribution weight assigned to the secondary region of interest, to obtain an initial palm image corresponding to the acquired image through reconstruction; determine an initial palm key region included in a palm region in the initial palm image, a palm part in the initial palm key region being related to an acquisition angle of the initial palm image; and perform local image enhancement on the initial palm key region based on the initial palm image to obtain a palm image corresponding to the initial palm image.

In an embodiment, the acquisition module 1302 is further configured to: assign, when performing super-resolution reconstruction on the acquired image, different contribution weights to the palm region of interest and the secondary region of interest, the contribution weight assigned to the palm region of interest being higher than the contribution weight assigned to the secondary region of interest, to obtain a to-be-denoised palm image corresponding to the acquired image through reconstruction; determine noise distribution information of the to-be-denoised palm image based on the to-be-denoised palm image; extract an image feature of the to-be-denoised palm image, and remove a noise feature from the image feature according to the noise distribution information to obtain an image structure feature; and perform image reconstruction based on the image structure feature to obtain a denoised palm image for the to-be-denoised palm image.

In an embodiment, the palm image is obtained by reconstruction through a pre-trained super-resolution model. As shown in FIG. 14, the palm feature processing apparatus 1300 for identity authentication further includes:
a first training module 1310 configured to acquire at least one set of first palm image pairs, where the first palm image pair includes a first sample palm image and a reference palm image; the reference palm image has a higher resolution than a corresponding first sample palm image; the first sample palm image carries a first label of interest, and the first label of interest indicates a sample palm region of interest included in a palm region in the first sample palm image; a palm part in the sample palm region of interest is related to an acquisition angle of the first sample palm image; the palm region in the first sample palm image further includes a sample secondary region of interest except the sample palm region of interest; and the first label of interest is configured for indicating that when super-resolution reconstruction is performed on the first sample palm image, different contribution weights are assigned to the sample palm region of interest and the sample secondary region of interest, and a contribution weight assigned to the sample palm region of interest is higher than a contribution weight assigned to the sample secondary region of interest; input the first sample palm image to a to-be-trained super-resolution model to obtain a reconstructed palm image; and train the to-be-trained super-resolution model according to a difference between the reconstructed palm image and a corresponding reference palm image to obtain a trained super-resolution model.

In an embodiment, the single-angle palm feature is obtained by extraction through a pre-trained feature extraction model. As shown in FIG. 14, the palm feature processing apparatus 1300 for identity authentication further includes:
a second training module 1312 configured to acquire at least one set of second palm image pairs, where the second palm image pair includes a label palm image and a second sample palm image; the label palm image carries a second label of interest, and the second label of interest indicates a sample palm key region included in a palm region in the label palm image; a palm part in the sample palm key region is related to an acquisition angle of the label palm image; and the second label of interest is configured for indicating that when feature extraction is performed on the label palm image, different contribution weights are assigned to the sample palm key region and a sample auxiliary region, and a contribution weight assigned to the sample palm key region is higher than a contribution weight assigned to the sample auxiliary region; input the label palm image to a to-be-trained feature extraction model to obtain a reference single-angle palm feature through extraction; input the second sample palm image to the to-be-trained feature extraction model to obtain a predicted single-angle palm feature through extraction; and train the to-be-trained feature extraction model according to a difference between the predicted single-angle palm feature and a corresponding reference single-angle palm feature to obtain a trained feature extraction model.

In an embodiment, the fusion module 1308 is further configured to: determine the acquisition angles corresponding to the plurality of palm images; assign, according to the acquisition angles corresponding to the plurality of palm images, respective fusion weights to the single-angle palm features corresponding to the plurality of palm images; and fuse the single-angle palm features of the plurality of palm images according to the respective fusion weights of the single-angle palm features corresponding to the plurality of palm images to obtain the multi-angle palm feature of the palm.

In an embodiment, the multi-angle palm feature is obtained by fusing the single-angle palm features of the plurality of palm images in a target fusion manner. As shown in FIG. 14, the palm feature processing apparatus 1300 for identity authentication further includes:
a determining module 1314 configured to acquire a plurality of test palm images and first reference categories to which the test palm images belong, the plurality of test palm images being acquired for different test palms at different acquisition angles; determine, based on test palm images obtained by acquiring the same test palm at different acquisition angles, test single-angle palm features of the same test palm at different acquisition angles; determine multiple candidate fusion manners; fuse, for each candidate fusion manner, the test single-angle palm features of the same test palm at different acquisition angles according to the candidate fusion manner to obtain a test multi-angle palm feature corresponding to the candidate fusion manner; input the test palm image and the test multi-angle palm feature to a pre-trained palm classification model to perform category prediction on the test palm image through the pre-trained palm classification model based on the test multi-angle palm feature to obtain a first predicted category to which the test palm image belongs corresponding to the candidate fusion manner; and determine the target fusion manner from the multiple candidate fusion manners according to differences between first predicted categories corresponding to the candidate fusion manners and the first reference categories.

In an embodiment, as shown in FIG. 14, the palm feature processing apparatus 1300 for identity authentication further includes:
a third training module 1316 configured to acquire at least one third sample palm image and a second reference category to which the third sample palm image belongs, third sample palm images being acquired for different sample palms at different acquisition angles; determine, based on third sample palm images obtained by acquiring the same sample palm at different acquisition angles, sample single-angle palm features of the same sample palm at different acquisition angles; fuse the sample single-angle palm features of the same sample palm at different acquisition angles to obtain a sample multi-angle palm feature of the sample palm; input the third sample palm image and the sample multi-angle palm feature to a to-be-trained palm classification model to perform category prediction on the third sample palm image through the to-be-trained palm classification model based on the sample multi-angle palm feature to obtain a second predicted category to which the third sample palm image belongs; and train the to-be-trained palm classification model according to a difference between the second predicted category and the second reference category to obtain a trained palm classification model.

In an embodiment, the multi-angle palm feature and a user identity identifier of a user to which the palm belongs are associatively stored in a palm feature library. As shown in FIG. 14, the palm feature processing apparatus 1300 for identity authentication further includes:
an authentication module 1318 configured to acquire a to-be-recognized target palm image, and perform palm feature extraction on the to-be-recognized target palm image to obtain a target palm feature; search multi-angle palm features stored in the palm feature library for a target multi-angle palm feature that satisfies a similarity condition with the target palm feature; and determine, when the target multi-angle palm feature is found, an identity authentication result according to a user identity identifier associated with the target multi-angle palm feature.

In an embodiment, the multi-angle palm feature is obtained by fusing the single-angle palm features of the plurality of palm images according to a predetermined target fusion manner; and the single-angle palm features of the plurality of palm images and the multi-angle palm feature are associatively stored in the palm feature library. The fusion module 1308 is further configured to re-fuse, when the target fusion manner is updated, the single-angle palm features associated with the plurality of palm images in the palm feature library according to an updated fusion manner to obtain a re-fused multi-angle palm feature of the palm; and update the multi-angle palm feature in the palm feature library to the re-fused multi-angle palm feature.

According to the foregoing palm feature processing apparatus for identity authentication, the plurality of palm images of the same palm at different acquisition angles are acquired. For each palm image, the palm key region included in the palm region in the palm image is positioned, and the auxiliary region except the palm key region in the palm region is determined. The palm part in the palm key region is related to the acquisition angle of the palm image. Feature extraction is performed on the palm image, and different contribution weights are assigned to the palm key region and the auxiliary region in the palm image during feature extraction to obtain the single-angle palm feature of the palm image. The contribution weight assigned to the palm key region in the palm image is higher than the contribution weight assigned to the auxiliary region in the palm image. The single-angle palm features of the plurality of palm images are fused to obtain the multi-angle palm feature of the palm, and the multi-angle palm feature may be configured for identity authentication. Compared with a traditional manner of performing identity authentication based on a single-angle palm image, in this application, the plurality of palm images of the same palm at different acquisition angles are acquired, and the palm key region of the palm image is positioned so that more attention is paid to the palm key region during feature extraction to extract a single-angle palm feature of the palm image that is more accurately positioned. Further, the single-angle palm features of the palm images are fused into a richer and more accurate multi-angle palm feature, and identity authentication is performed based on the richer and more accurate multi-angle palm feature so that the accuracy of identity authentication may be improved, thereby avoiding the waste of hardware resources configured for supporting the identity authentication function.

All or some of the modules in the foregoing palm feature processing apparatus for identity authentication may be implemented by software, hardware, and a combination thereof. The foregoing modules may be embedded in the form of hardware or stored separately from a processor in a computer device, or may be stored in the form of software in a memory of the computer device, facilitating the processor to invoke the above-mentioned modules to perform the corresponding operations.

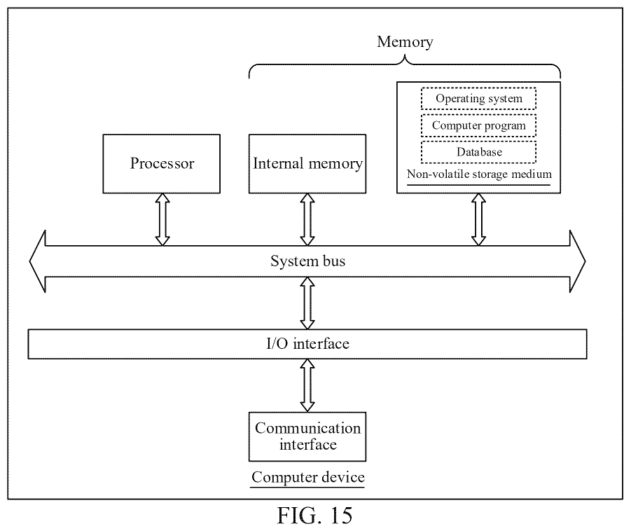

In an embodiment, a computer device is provided. The computer device may be a server, and its internal structure may be shown in FIG. 15. The computer device includes a processor, a memory, an input/output (I/O) interface, and a communication interface. The processor, the memory, and the I/O interface are connected through a system bus, and the communication interface is connected to the system bus through the I/O interface. The processor of the computer device is configured to provide calculation and control capabilities. The memory of the computer device includes a non-volatile storage medium and an internal memory. The non-volatile storage medium stores an operating system, a computer program, and a database. The internal memory provides an environment for running the operating system and the computer program in the non-volatile storage medium. The I/O interface of the computer device is configured to exchange information between the processor and an external device. The communication interface of the computer device is configured to communicate with an external terminal through a network connection. The computer program, when executed by the processor, implements the palm feature processing method for identity authentication.

It will be appreciated by a person skilled in the art that the structure shown in FIG. 15 is merely a block diagram of a portion of the structure relevant to the solution of this application and does not constitute a limitation on the computer device to which the solution of this application is applied. A specific computer device may include more or fewer components than those shown in the drawings, a combination of some components, or a different arrangement of components.

In an embodiment, a computer device is further provided, including a memory and a processor. The memory has a computer program stored therein, and the processor, when executing the computer program, implements the operations in the foregoing method embodiments.

In an embodiment, a computer-readable storage medium is provided, having a computer program stored therein. The computer program, when executed by a processor, implements the operations in the foregoing method embodiments.

In an embodiment, a computer program product is provided, including a computer program. The computer program, when executed by a processor, implements the operations in the foregoing method embodiments.

User information (including, but not limited to, user device information, user personal information, and the like) and data (including, but not limited to, data for analysis, data for storage, data for displaying, and the like) involved in this application are all information and data authorized by users or fully authorized by all parties, and acquisition, use, and processing of relevant data need to comply with relevant laws, regulations, and standards of relevant countries and regions.

A person skilled in the art may understand that all or some of procedures of the method in the foregoing embodiments may be accomplished by instructing the relevant hardware through the computer program. The computer program may be stored in a non-volatile computer-readable storage medium and may include the procedures of the foregoing method embodiments when executed. Any reference to the memory, storage, database, or another medium used in the embodiments provided in this application may include at least one of a non-volatile memory and a volatile memory. The non-volatile memory may include a read-only memory (ROM), a magnetic tape, a floppy disk, a flash memory, or an optical memory. The volatile memory may include a random access memory (RAM) or an external cache memory. By way of illustration and not limitation, the RAM may be in a variety of forms, such as a static random access memory (SRAM) or a dynamic random access memory (DRAM).

Technical features of the foregoing embodiments may be randomly combined. To make description concise, not all possible combinations of the technical features in the foregoing embodiments are described. However, as long as no conflict exists, the combinations of these technical features shall be considered as falling within the scope recorded by this specification.

The foregoing embodiments only describe several implementations of this application, which are described specifically and in detail, but cannot be construed as a limitation to the patent scope of this application. For a person skilled in the art, several transformations and improvements may be made without departing from the idea of this application. These transformations and improvements belong to the protection scope of this application. Therefore, the protection scope of the patent of this application shall be subject to the appended claims.

What is claimed is:

1. A method for palm feature-based identity authentication performed by a computer device, the method:
acquiring a plurality of palm images of a palm at different acquisition angles;
for each palm image, positioning a palm key region in the palm image according to an acquisition angle of the palm image and determining an auxiliary region in the palm image except the palm key region;
performing feature extraction on the palm image to obtain a single-angle palm feature of the palm image, a contribution weight assigned to the palm key region in the palm image being higher than a contribution weight assigned to the auxiliary region in the palm image;
fusing single-angle palm features of the plurality of palm images to obtain a multi-angle palm feature of the palm; and
performing identity authentication using the multi-angle palm feature.

2. The method according to claim 1, wherein the acquiring the plurality of palm images of the palm at different acquisition angles comprises:
acquiring a plurality of raw images of the palm at different acquisition angles; and
performing super-resolution reconstruction on the plurality of raw images to correspondingly obtain the plurality of palm images, a resolution of the palm image being higher than a resolution of a raw image corresponding to the palm image.

3. The method according to claim 2, wherein the performing super-resolution reconstruction on the plurality of raw images to correspondingly obtain the plurality of palm images comprises:
for each raw image, determining a palm region of interest in the raw image according to an acquisition angle of the raw image, and determining a secondary region of interest except the palm region of interest in the raw image; and
assigning, when performing super-resolution reconstruction on the raw image, different contribution weights to the palm region of interest and the secondary region of interest to obtain the palm image corresponding to the raw image through reconstruction.

4. The method according to claim 1, wherein the single-angle palm feature of the palm image is obtained by extraction through a pre-trained feature extraction model, and the method further comprises:
acquiring at least one set of second palm image pairs, wherein the second palm image pair comprises a label palm image and a second sample palm image; the label palm image carries a second label of interest, the second label of interest indicates a sample palm key region comprised in a palm region in the label palm image, and a palm part in the sample palm key region is related to an acquisition angle of the label palm image; the palm region in the label palm image further comprises a sample auxiliary region except the sample palm key region; and the second label of interest is configured for indicating that when feature extraction is performed on the label palm image, different contribution weights are assigned to the sample palm key region and the sample auxiliary region, and a contribution weight assigned to the sample palm key region is higher than a contribution weight assigned to the sample auxiliary region;
inputting the label palm image to a to-be-trained feature extraction model to obtain a reference single-angle palm feature through extraction;
inputting the second sample palm image to the to-be-trained feature extraction model to obtain a predicted single-angle palm feature through extraction; and
training the to-be-trained feature extraction model according to a difference between the predicted single-angle palm feature and a corresponding reference single-angle palm feature to obtain a trained feature extraction model.

5. The method according to claim 1, wherein the fusing single-angle palm features of the plurality of palm images to obtain the multi-angle palm feature of the palm comprises:
determining the acquisition angles corresponding to the plurality of palm images;
assigning, according to the acquisition angles corresponding to the plurality of palm images, respective fusion weights to the single-angle palm features corresponding to the plurality of palm images; and
fusing the single-angle palm features of the plurality of palm images according to the respective fusion weights of the single-angle palm features corresponding to the plurality of palm images to obtain the multi-angle palm feature of the palm.

6. The method according to claim 1, wherein the multi-angle palm feature is obtained by fusing the single-angle palm features of the plurality of palm images in a target fusion manner, and the method further comprises:
acquiring a plurality of test palm images and first reference categories to which the test palm images belong, the plurality of test palm images being acquired for different test palms at different acquisition angles;
determining, based on test palm images obtained by acquiring the same test palm at different acquisition angles, test single-angle palm features of the same test palm at different acquisition angles;
determining multiple candidate fusion manners;
fusing, for each candidate fusion manner, the test single-angle palm features of the same test palm at different acquisition angles according to the candidate fusion manner to obtain a test multi-angle palm feature corresponding to the candidate fusion manner;
inputting the test palm image and the test multi-angle palm feature to a pre-trained palm classification model to perform category prediction on the test palm image through the pre-trained palm classification model based on the test multi-angle palm feature to obtain a first predicted category to which the test palm image belongs corresponding to the candidate fusion manner; and
determining the target fusion manner from the multiple candidate fusion manners according to differences between first predicted categories corresponding to the candidate fusion manners and the first reference categories.

7. The method according to claim 1, wherein the multi-angle palm feature and a user identity identifier of a user to which the palm belongs are associatively stored in a palm feature library, and the performing identity authentication using the multi-angle palm feature further comprises:
performing palm feature extraction on a target palm image to obtain a target palm feature;
searching multi-angle palm features stored in the palm feature library for a target multi-angle palm feature that satisfies a similarity condition with the target palm feature; and
determining, when the target multi-angle palm feature is found, an identity authentication result according to a user identity identifier associated with the target multi-angle palm feature.

8. A computer device, comprising a memory and a processor, the memory having a computer program stored therein, and the computer program, when executed by the processor, causing the computer device to implement a method for palm feature-based identity authentication including:
acquiring a plurality of palm images of a palm at different acquisition angles;
for each palm image, positioning a palm key region in the palm image according to an acquisition angle of the palm image and determining an auxiliary region in the palm image except the palm key region;
performing feature extraction on the palm image to obtain a single-angle palm feature of the palm image, a contribution weight assigned to the palm key region in the palm image being higher than a contribution weight assigned to the auxiliary region in the palm image;
fusing single-angle palm features of the plurality of palm images to obtain a multi-angle palm feature of the palm; and
performing identity authentication using the multi-angle palm feature.

9. The computer device according to claim 8, wherein the acquiring the plurality of palm images of the palm at different acquisition angles comprises:
acquiring a plurality of raw images of the palm at different acquisition angles; and
performing super-resolution reconstruction on the plurality of raw images to correspondingly obtain the plurality of palm images, a resolution of the palm image being higher than a resolution of a raw image corresponding to the palm image.

10. The computer device according to claim 9, wherein the performing super-resolution reconstruction on the plurality of raw images to correspondingly obtain the plurality of palm images comprises:
for each raw image, determining a palm region of interest in the raw image according to an acquisition angle of the raw image, and determining a secondary region of interest except the palm region of interest in the raw image; and
assigning, when performing super-resolution reconstruction on the raw image, different contribution weights to the palm region of interest and the secondary region of interest to obtain the palm image corresponding to the raw image through reconstruction.

11. The computer device according to claim 8, wherein the single-angle palm feature of the palm image is obtained by extraction through a pre-trained feature extraction model, and the method further comprises:
acquiring at least one set of second palm image pairs, wherein the second palm image pair comprises a label palm image and a second sample palm image; the label palm image carries a second label of interest, the second label of interest indicates a sample palm key region comprised in a palm region in the label palm image, and a palm part in the sample palm key region is related to an acquisition angle of the label palm image; the palm region in the label palm image further comprises a sample auxiliary region except the sample palm key region; and the second label of interest is configured for indicating that when feature extraction is performed on the label palm image, different contribution weights are assigned to the sample palm key region and the sample auxiliary region, and a contribution weight assigned to the sample palm key region is higher than a contribution weight assigned to the sample auxiliary region;
inputting the label palm image to a to-be-trained feature extraction model to obtain a reference single-angle palm feature through extraction;
inputting the second sample palm image to the to-be-trained feature extraction model to obtain a predicted single-angle palm feature through extraction; and
training the to-be-trained feature extraction model according to a difference between the predicted single-angle palm feature and a corresponding reference single-angle palm feature to obtain a trained feature extraction model.

12. The computer device according to claim 8, wherein the fusing single-angle palm features of the plurality of palm images to obtain the multi-angle palm feature of the palm comprises:
determining the acquisition angles corresponding to the plurality of palm images;
assigning, according to the acquisition angles corresponding to the plurality of palm images, respective fusion weights to the single-angle palm features corresponding to the plurality of palm images; and
fusing the single-angle palm features of the plurality of palm images according to the respective fusion weights of the single-angle palm features corresponding to the plurality of palm images to obtain the multi-angle palm feature of the palm.

13. The computer device according to claim 8, wherein the multi-angle palm feature is obtained by fusing the single-angle palm features of the plurality of palm images in a target fusion manner, and the method further comprises:
acquiring a plurality of test palm images and first reference categories to which the test palm images belong, the plurality of test palm images being acquired for different test palms at different acquisition angles;
determining, based on test palm images obtained by acquiring the same test palm at different acquisition angles, test single-angle palm features of the same test palm at different acquisition angles;
determining multiple candidate fusion manners;
fusing, for each candidate fusion manner, the test single-angle palm features of the same test palm at different acquisition angles according to the candidate fusion manner to obtain a test multi-angle palm feature corresponding to the candidate fusion manner;
inputting the test palm image and the test multi-angle palm feature to a pre-trained palm classification model to perform category prediction on the test palm image through the pre-trained palm classification model based on the test multi-angle palm feature to obtain a first predicted category to which the test palm image belongs corresponding to the candidate fusion manner; and
determining the target fusion manner from the multiple candidate fusion manners according to differences between first predicted categories corresponding to the candidate fusion manners and the first reference categories.

14. The computer device according to claim 8, wherein the multi-angle palm feature and a user identity identifier of a user to which the palm belongs are associatively stored in a palm feature library, and the performing identity authentication using the multi-angle palm feature further comprises:
performing palm feature extraction on a target palm image to obtain a target palm feature;
searching multi-angle palm features stored in the palm feature library for a target multi-angle palm feature that satisfies a similarity condition with the target palm feature; and
determining, when the target multi-angle palm feature is found, an identity authentication result according to a user identity identifier associated with the target multi-angle palm feature.

15. A non-transitory computer-readable storage medium, having a computer program stored therein, the computer program, when executed by a processor of a computer device, causing the computer device to implement a method for palm feature-based identity authentication including:
acquiring a plurality of palm images of a palm at different acquisition angles;
for each palm image, positioning a palm key region in the palm image according to an acquisition angle of the palm image and determining an auxiliary region in the palm image except the palm key region;
performing feature extraction on the palm image to obtain a single-angle palm feature of the palm image, a contribution weight assigned to the palm key region in the palm image being higher than a contribution weight assigned to the auxiliary region in the palm image;
fusing single-angle palm features of the plurality of palm images to obtain a multi-angle palm feature of the palm; and
performing identity authentication using the multi-angle palm feature.

16. The non-transitory computer-readable storage medium according to claim 15, wherein the acquiring the plurality of palm images of the palm at different acquisition angles comprises:
acquiring a plurality of raw images of the palm at different acquisition angles; and
performing super-resolution reconstruction on the plurality of raw images to correspondingly obtain the plurality of palm images, a resolution of the palm image being higher than a resolution of a raw image corresponding to the palm image.

17. The non-transitory computer-readable storage medium according to claim 15, wherein the single-angle palm feature of the palm image is obtained by extraction through a pre-trained feature extraction model, and the method further comprises:
acquiring at least one set of second palm image pairs, wherein the second palm image pair comprises a label palm image and a second sample palm image; the label palm image carries a second label of interest, the second label of interest indicates a sample palm key region comprised in a palm region in the label palm image, and a palm part in the sample palm key region is related to an acquisition angle of the label palm image; the palm region in the label palm image further comprises a sample auxiliary region except the sample palm key region; and the second label of interest is configured for indicating that when feature extraction is performed on the label palm image, different contribution weights are assigned to the sample palm key region and the sample auxiliary region, and a contribution weight assigned to the sample palm key region is higher than a contribution weight assigned to the sample auxiliary region;
inputting the label palm image to a to-be-trained feature extraction model to obtain a reference single-angle palm feature through extraction;
inputting the second sample palm image to the to-be-trained feature extraction model to obtain a predicted single-angle palm feature through extraction; and
training the to-be-trained feature extraction model according to a difference between the predicted single-angle palm feature and a corresponding reference single-angle palm feature to obtain a trained feature extraction model.

18. The non-transitory computer-readable storage medium according to claim 15, wherein the fusing single-angle palm features of the plurality of palm images to obtain the multi-angle palm feature of the palm comprises:
determining the acquisition angles corresponding to the plurality of palm images;
assigning, according to the acquisition angles corresponding to the plurality of palm images, respective fusion weights to the single-angle palm features corresponding to the plurality of palm images; and
fusing the single-angle palm features of the plurality of palm images according to the respective fusion weights of the single-angle palm features corresponding to the plurality of palm images to obtain the multi-angle palm feature of the palm.

19. The non-transitory computer-readable storage medium according to claim 15, wherein the multi-angle palm feature is obtained by fusing the single-angle palm features of the plurality of palm images in a target fusion manner, and the method further comprises:
acquiring a plurality of test palm images and first reference categories to which the test palm images belong, the plurality of test palm images being acquired for different test palms at different acquisition angles;
determining, based on test palm images obtained by acquiring the same test palm at different acquisition angles, test single-angle palm features of the same test palm at different acquisition angles;
determining multiple candidate fusion manners;
fusing, for each candidate fusion manner, the test single-angle palm features of the same test palm at different acquisition angles according to the candidate fusion manner to obtain a test multi-angle palm feature corresponding to the candidate fusion manner;
inputting the test palm image and the test multi-angle palm feature to a pre-trained palm classification model to perform category prediction on the test palm image through the pre-trained palm classification model based on the test multi-angle palm feature to obtain a first predicted category to which the test palm image belongs corresponding to the candidate fusion manner; and
determining the target fusion manner from the multiple candidate fusion manners according to differences between first predicted categories corresponding to the candidate fusion manners and the first reference categories.

20. The non-transitory computer-readable storage medium according to claim 15, wherein the multi-angle palm feature and a user identity identifier of a user to which the palm belongs are associatively stored in a palm feature library, and the performing identity authentication using the multi-angle palm feature further comprises:
performing palm feature extraction on a target palm image to obtain a target palm feature;
searching multi-angle palm features stored in the palm feature library for a target multi-angle palm feature that satisfies a similarity condition with the target palm feature; and
determining, when the target multi-angle palm feature is found, an identity authentication result according to a user identity identifier associated with the target multi-angle palm feature.
